(19) United States
(12) Patent Application Publication
(10) Pub. No.: US 2007/0181251 A1
(43) Pub. Date: Aug. 9, 2007

(54) Belt or roller for OA apparatus, manufacturing method thereof, and OA apparatus using the same

(76) Inventors: Kazuaki Ikeda, Osaka (JP); Masahiko Komiyama, Osaka (JP); Hiroshi Okazaki, Osaka (JP)

Correspondence Address: MCDERMOTT WILL & EMERY LLP, 600 13TH STREET, N.W., WASHINGTON, DC, 20005-3096, US

(21) Appl. No.: 11/704,219

(22) Filed: Feb. 9, 2007

(30) Foreign Application Priority Data
Feb. 9, 2006 (JP) 2006-032201
Apr. 21, 2006 (JP) 2006-118394
Apr. 21, 2006 (JP) 2006-118410
May 30, 2006 (JP) 2006-150607
Sep. 5, 2006 (JP) 2006-240627

(51) Int. Cl. G11B 11/105; B32B 27/00; B32B 25/08

(52) U.S. Cl. 156/294; 428/421; 428/409; 428/332; 428/492; 428/494

(57) ABSTRACT

A belt or a roller for OA apparatus, in which a top layer includes a base material formed from PTFE, PFA or a mixture thereof and having a continuous structure and the PTFE, the PFA or the mixture thereof occupies at least 70% of the base material in weight excluding a conductive agent, is provided. The belt or the roller for OA apparatus can attain sufficient toner detachability with respect to toner including chemical toner, and has excellent resistance to physical and/or mechanical stress and resistance to electrical stress. A method of manufacturing the belt or the roller for OA apparatus and an OA apparatus employing the belt or the roller are also provided.

### BACKGROUND OF THE INVENTION

1. Field of the Invention

The present invention relates to a belt or a roller for OA apparatus, and more particularly to a belt or a roller for OA apparatus applied as a transfer belt, a transfer/fusion belt, a development roller, a charge roller, a fusion roller, and the like used in an image-forming apparatus adapted to electrophotography such as a color copying machine, a color printer, and a color multi-function peripheral.

In addition, the present invention also relates to a method of manufacturing the belt or the roller for OA apparatus of the present invention and to an OA apparatus employing the belt or the roller for OA apparatus.

2. Description of the Background Art

In an OA apparatus including an image-forming apparatus adapted to electrophotography such as a copying machine, a printer and the like, a system for transferring a toner image formed on a photoconductive drum to a transfer material (paper) using a transfer belt, and fusing the toner image to the transfer material by heating and pressing with a fusion belt (what is called an endless belt) and a fusion roller is becoming the standard. Accordingly, in such an OA apparatus, a belt or a roller of a single-layer or multilayer structure is mainly used for charging, development, transfer, fusion, paper feed, and the like.

FIG. 15 is a diagram schematically showing an intermediate transfer system representing an example of a transfer system in a color image-forming apparatus such as a color copying machine, a color laser printer and the like. As shown in FIG. 15, a toner image is formed on a photoconductive drum 53 by means of toner 51 and a development roller 52. As this system is adapted to a 4-drum tandem system, development rollers and photoconductive drums corresponding to black toner (K) and toner of three colors (cyan C, magenta M, yellow Y) respectively are provided. The toner image formed on photoconductive drum 53 is transferred to a transfer belt 55 for image-forming apparatus by means of a primary transfer roller 54, photoconductive drum 53 and transfer belt 55 for image-forming apparatus. The formed color image is in turn transferred to a transfer material (paper) 57 by means of a secondary transfer roller 56, transfer belt 55 for image-forming apparatus and transfer material (paper) 57, and fused by a fusion roller (not shown). The basic principle is also the same in a multitransfer system.

In transfer employing the above-described principle, for such reasons as use of static electricity in toner transfer and characteristics of fine powder toner that it is not only essentially likely to adhere to a substance but also likely to adhere electrostatically to a charge-bearing substance, the belt or the roller used in the OA apparatus is required not only simply to have excellent toner detachability (toner detachment characteristic) but also to have moderate charge-bearing property.

In addition, in order to form a sharp color image, moderate elasticity in addition to strength are also required in the transfer belt, the fusion roller, and the like. This is because not only sufficient heat-fusion of toner of four colors should be achieved but also color-mixing and beautiful representation of a neutral tint and tone should be achieved.

Accordingly, it has been proposed to form the belt or the roller for OA apparatus by layering (combining) a rubber elastic body or a foam and a metal or a resin-molded body. In addition, for various purposes such as prevention of contamination of a counterpart member such as a photoconductive drum, prevention of toner adhesion, charge control of the toner, resistance adjustment, and improvement in toner detachability, a large number of belts or rollers that have a top layer made of resin excellent in above-mentioned characteristics formed on the surface of the rubber-like elastic body or the foam have been developed.

Moreover, a belt or a roller (such as an endless transfer belt and an endless transfer/fusion belt), having such a multilayer (three-layered) structure that an elastic layer is formed around an outer circumference of a single-layer resin belt or roller composed, for example, of polyimide, polyamide imide, PVDF (polyvinylidene fluoride), or the like and a top layer is further provided on the outer circumference thereof, has become commercially available.

The top layer of the transfer belt is required to have the following characteristics.

1) The surface of the top layer is smooth and an angle of contact is great, so that toner is readily transferred from the top layer to the transfer material (paper) (excellent toner detachability). In particular, in recent days, there is tendency from toner manufactured with a mechanical crushing method to chemical toner that is chemically manufactured. As the chemical toner has a small particle size and a spherical shape, the chemical toner readily adheres to a belt material and hence it should have sufficient toner detachability.

2) As a factor of physical and/or mechanical deterioration (hereinafter, referred to as “stress”) such as repeatedly applied pressure and bending as well as electrical stress attributed to charges for moving the toner are simultaneously imposed, long-time resistance against these two stresses should be possessed.

Conventionally, for example, in order to improve toner detachability described in 1), such methods as mixing fine particles of a fluorine-based resin such as PTFE (polytetrafluoroethylene), PFA (tetrafluoroethylene-perfluoroalkyl vinyl ether) or the like in a urethane paint, an acrylic paint, an epoxy paint, and/or a silicone paint, mixing in a urethane raw material in advance a fluoroplastic having a special functional group readily bound to the urethane raw material for reaction at that time, or employing a lower fluorine compound such as fluorocarbon rubber or PVDF for the top layer, have been adopted (see Japanese Patent Laying-Open No. 2002-229345, Japanese Patent No. 3552868, and the like).

Moreover, in addition to the characteristics described above, normally, the following characteristics are also required in the belt or the roller for OA apparatus. Specifically, the belt or the roller has large surface resistivity (resistivity in a circumferential direction) and volume resistivity (resistivity in a direction of thickness) smaller than the surface resistivity; the surface resistivity and the volume resistivity do not fluctuate depending on a position on the belt or roller surface and/or an environment of use, tensile modulus of elasticity in the circumferential direction of the belt or the roller is high, the photoconductive drum and the toner are not chemically contaminated (excellent non-contamination property); and the belt or the roller is flame-resistant.

In view of the fact that the single-layer transfer belt for image-forming apparatus has difficulty in satisfying the large number of characteristics described above, for example, Japanese Patent Laying-Open No. 2002-287531 has proposed a transfer belt of a multilayer structure for image-forming apparatus including a base layer formed from a thermoplastic elastomer having a low resistance value and a top layer formed from a thermoplastic elastomer having a high resistance value, the base layer and the top layer being formed by heating and molding.

### SUMMARY OF THE INVENTION

Meanwhile, conventionally, a paint such as urethane resin has been used for the base material of the top layer (a material, a base resin or a matrix resin that has a continuous structure so that it is responsible for its original roles such as holding an overall shape, dimension, strength, and the like). Though PTFE and/or PFA mixed with this base material exhibits excellent toner detachability, the base material itself has poor toner detachability. Accordingly, toner detachability of the belt or the roller is determined dominantly by the material poor in its characteristics, and an effect of improvement in toner detachability of the obtained belt or roller has been limited.

Alternatively, toner detachability can be attained to some extent by mixing a lower fluoroplastic such as a fluoroplastic having a special functional group, fluorocarbon rubber or PVDF. Mixing of such a lower fluoroplastic in the base material, however, has not been able to solve the problem with regard to the chemical toner disadvantageous in its detachability that has recently been used.

Further, an attempt to increase an amount of adding a fluorine compound such as PTFE and/or PFA has been made in order to improve toner detachability. Inversely with the increase in the amount of addition, however, resistance to bending of the belt or the roller is significantly lowered, damage such as crack in the top layer tends to occur at an early stage during use, and in turn resistance to physical and/or mechanical stress and resistance to electrical stress mentioned in 2) above are lowered.

The present invention was made to solve the above-described problems. An object of the present invention is to provide a belt or a roller for OA apparatus, capable of exhibiting sufficient toner detachability with respect to toner including chemical toner and having excellent resistance to physical and/or mechanical stress and resistance to electrical stress.

In a belt or a roller for OA apparatus according to the present invention, a top layer includes a base material formed from PTFE, PFA or a mixture thereof and having a continuous structure, and the PTFE, the PFA or the mixture thereof occupies at least 70% of the base material in weight excluding a conductive agent.

According to the belt or the roller for OA apparatus of the present invention, as compared with a conventional example, a belt for OA apparatus, having drastically improved toner detachability and also excellent in endurance against physical and/or mechanical stress and electrical stress attributed to charging, is obtained.

In the belt or the roller for OA apparatus of the present invention, preferably, melt flow rate of the PTFE, the PFA or the mixture thereof forming the base material is at most 14 g/10 minutes (372° C., load 5 kg).

In the present invention, preferably, the base material is formed from a mixture of the PTFE and the PFA, and the PFA occupies 50 weight % with respect to the total weight of the PTFE and the PFA.

In addition, preferably, the base material is formed from the PFA or a mixture of the PFA and the PTFE having a melting point of at most 300° C.

The belt or the roller for OA apparatus of the present invention is preferably used as a transfer belt or a transfer/fusion belt.

In addition, if the belt or the roller for OA apparatus of the present invention is used as any one of a transfer belt, a transfer/fusion belt, a development roller, a charge roller, and a fusion roller for image-forming apparatus, (RfSO₂)₂NLi where Rf represents perfluoroalkyl group is preferably blended in the PTFE, the PFA or the mixture thereof forming the base material.

Here, preferably, (RfSO₂)₂NLi is (CF₃SO₂)₂NLi or (C₂F₅SO₂)₂NLi.

In addition, preferably, 0.003 to 3.0 parts by weight (RfSO₂)₂NLi is blended in 100 parts by weight PTFE, PFA or the mixture thereof.

In addition, if (RfSO₂)₂NLi where Rf represents perfluoroalkyl group is blended, preferably, the top layer has surface resistivity in a range from 1.00E+10 to 9.99E+14Ω/□ and the top layer has a thickness in a range from 1 to 30 μm.

If the belt or the roller for OA apparatus of the present invention is used as a transfer belt for image-forming apparatus, preferably, the transfer belt for image-forming apparatus has such a structure that a base layer, an intermediate layer formed from an elastomer and the top layer are stacked in this order, and the base layer has surface resistivity higher than that of the intermediate layer.

Here, preferably, the intermediate layer is formed from an ion-conductive elastomer.

Alternatively, if the belt or the roller for OA apparatus of the present invention is used as a transfer belt for image-forming apparatus, the intermediate layer is preferably formed from one type of elastomer or a plurality of types of elastomers selected from urethane, NBR, EP, SR, and polyamide.

In addition, a binder layer formed from a fluorine-containing polymer may be interposed between the intermediate layer and the top layer, and the binder layer may be formed from a material having a melting point equal to or lower than a point of thermal decomposition of the elastomer forming the intermediate layer, and a point of thermal decomposition equal to or higher than a melting point of the PTFE, the PFA or the mixture thereof forming the base material of the top layer.

Alternatively, if the belt or the roller for OA apparatus of the present invention is used as a multilayer endless belt for image-forming apparatus, preferably, the multilayer endless belt for image-forming apparatus has such a structure that a base layer, an intermediate layer formed from an elastomer and the top layer are stacked in this order, and a surface of the top layer on a side adjacent to the intermediate layer is subjected to an adhesion property improvement treatment.

Here, preferably, the adhesion property improvement treatment is a treatment for providing polarity to a molecule of the PTFE, the PFA or the mixture thereof on the surface of the top layer adjacent to the intermediate layer.

The adhesion property improvement treatment is preferably a plasma treatment.

In addition, preferably, the surface of the top layer subjected to the adhesion property improvement treatment is adhered to the intermediate layer by heat-sealing.

In addition, the present invention also provides a method of manufacturing the belt or the roller for OA apparatus, if the belt or the roller for OA apparatus of the present invention is used as a multilayer endless belt for image-forming apparatus having such a structure that a base layer, an intermediate layer formed from an elastomer and the top layer are stacked in this order, where a surface of the top layer on the side adjacent to the intermediate layer is subjected to adhesion property improvement treatment. The method of manufacturing the belt or the roller for OA apparatus of the present invention includes the steps of: fabricating a composite body having the intermediate layer formed on the base layer; fabricating the top layer having one surface subjected to the adhesion property improvement treatment; and adhering the intermediate layer of the composite body to the surface of the top layer subjected to the adhesion property improvement treatment.

The present invention also provides an OA apparatus including the belt or the roller for OA apparatus according to the present invention described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically showing a transfer belt 1 for an image-forming apparatus representing a preferred example of the present invention.

FIG. 2 is a cross-sectional view schematically showing a transfer belt 1′ for an image-forming apparatus representing a preferred example of the present invention.

FIG. 3 is a perspective view schematically showing a state where a first composite body consisting of a top layer 2 and a binder layer 5 is formed on an inner surface of an outer cylinder 11.

FIG. 4 is a perspective view schematically showing a state where a second composite body consisting of a base layer 3 and an intermediate layer 4 is formed on an outer surface of a drum-shaped mold 12.

FIG. 5 is a perspective view schematically showing a state where a core 13 is inserted in the second composite body consisting of base layer 3 and intermediate layer 4.

FIG. 6 is a perspective view schematically showing a state where the second composite body consisting of base layer 3 and intermediate layer 4 in such a state that core 13 is inserted therein is inserted in the first composite body consisting of top layer 2 and binder layer 5 formed on the inner surface of an outer cylinder 11.

FIG. 7 is a cross-sectional view schematically showing an example where core 13 made of an elastic body is used and heat-sealing between top layer 2 and intermediate layer 4 is performed.

FIG. 8 is a cross-sectional view schematically showing another example where core 13 made of an elastic body is used and heat-sealing between top layer 2 and intermediate layer 4 is performed.

FIG. 9 schematically shows a water bag 21 that can suitably be used in manufacturing a belt or a roller for OA apparatus of the present invention.

FIG. 10 schematically shows a state where water bag 21 in the example shown in FIG. 9 is used and heat-sealing between binder layer 5 and intermediate layer 4 is performed.

FIG. 11 is a conceptual diagram showing an apparatus for testing endurance used in experiment example 1, by applying physical and/or mechanical stress and charging stress to a transfer belt.

FIG. 12 is a graph showing relation between an amount of blending an ion-conductive agent and surface resistivity.

FIG. 13 is a graph showing relation between an amount of blending an ion-conductive agent and tensile strength.

FIG. 14 is a graph showing relation between an amount of blending an ion-conductive agent and elongation.

FIG. 15 schematically shows an image transfer system using a transfer belt for an image-forming apparatus.

### DESCRIPTION OF THE PREFERRED EMBODIMENTS

The present invention relates to a belt or a roller for OA apparatus, and applications of the “belt or roller for OA apparatus” are not limited so long as it is the belt or the roller using toner and requiring toner detachability. In addition, the “OA apparatus” in the present invention refers to an image-forming apparatus also adapted to monochrome (in principle, black) without using color, regardless of whether it is a copying machine, a printer, a multi-function peripheral, or the like. The “image-forming apparatus” in the present invention is not limited to an apparatus adapted to electrophotography, but encompasses all apparatuses attaining a function to form an image on a transfer material by forming a toner image and transferring the same to the transfer material.

The belt or the roller for OA apparatus of the present invention specifically encompasses a transfer belt, a transfer/fusion belt, a development roller, a charge roller, a transfer roller, a fusion roller, and the like. Among these, particularly, the “transfer belt” refers to a belt attaining a function to transfer a toner image formed on a photoconductive drum or the like to a transfer material such as paper in an image-forming apparatus.

In addition, the belt for OA apparatus of the present invention includes a “multilayer endless belt for image-forming apparatus.” Here, the “multilayer endless belt for image-forming apparatus” refers to an endless belt attaining a function to transfer and fuse a toner image formed on a photoconductive drum or the like to a transfer material such as paper. Moreover, particularly, the “endless belt” includes not only such an endless belt as used in a manner fitted between a plurality of rollers such as transfer belts, fusion belts, transfer/fusion belts, and the like and also serving to carry a transfer paper but also an endless belt used in a manner fitted to an outer circumferential surface of one roller such as a transfer roller, a charge roller, a development roller, and the like, so long as it is used in an image-forming apparatus. Further, a belt implemented by a very thin endless film is also encompassed, so long as it is of an endless belt type.

In the belt or the roller for OA apparatus of the present invention, a top layer includes a base material formed from PTFE (polytetrafluoroethylene), PFA (tetrafluoroethylene-perfluoroalkyl vinyl ether) or a mixture thereof and having a continuous structure, and the PTFE, the PFA or the mixture thereof occupies at least 70% of the base material in weight excluding a conductive agent. In the present invention, the “base material” refers to what is called a base polymer, namely, to a material responsible for original roles as the top layer, such as holding of an overall shape and dimension thereof and exhibition of toner detachability.

According to the belt or the roller for OA apparatus of the present invention, the top layer includes the base material formed from the PTFE, the PFA or the mixture thereof (contains as a forming material), and the PTFE, the PFA or the mixture thereof occupies at least 70% of the base material in weight excluding a conductive agent, so that excellent toner detachability can be attained. From the viewpoint of better toner detachability, preferably, the PTFE, the PFA or the mixture thereof occupies at least 90% of the base material in weight excluding a conductive agent.

The base material of the top layer in the present invention is preferably formed from a mixture of the PTFE and the PFA. By using the PTFE and the PFA together, further endurance can be obtained while maintaining excellent toner detachability. Namely, the belt or the roller for OA apparatus, having excellent toner detachability also for the chemical toner and having sufficient endurance against physical and/or mechanical stress and electrical stress, can be realized. Here, as the base material of the top layer has the continuous structure of the PTFE and the PFA, excellent toner detachability and bending property can be exhibited over the entire top layer.

Meanwhile, the base material of the top layer in the present invention may contain, in addition to the PTFE, the PFA or the mixture thereof, a tetrafluoroethylene-hexafluoropropylene copolymer, a tetrafluoroethylene-ethylene copolymer, and the like, so long as the effect of the present invention is not impaired.

In the belt or the roller for OA apparatus of the present invention, melt flow rate (MFR) of the PTFE, the PFA or the mixture thereof forming the base material is preferably not larger than 14 g/10 minutes (372° C., load 5 kg), and more preferably in a range from 1 g/10 minutes to 7 g/10 minutes. Here, MFR represents an index for melt viscosity and MFR is not necessarily in proportion to molecular weight. In general, however, as the value of MFR is smaller, molecular weight becomes greater and endurance of a product improves. If MFR is too small (specifically, less than 1 g/10 minutes), leveling during calcining (fusion) in manufacturing becomes insufficient and a continuous film that elongates well is less likely.

It is noted that MFR represents a value measured under such conditions as a load at 372° C., for example, in compliance with ASTM D1238.

As described above, the mixture of the PTFE and the PFA is preferably used for the base material of the top layer in the present invention. Here, a mixing ratio is not particularly limited, however, from the viewpoint of further improvement in bending property, a ratio of the PFA to the total weight of the PTFE and the PFA is preferably set to 50 weight % or greater. If the ratio of the PFA to the total weight of the PTFE and the PFA is set to 50 weight % or greater, it is considered that, as perfluoroalkyl group is added to the PFA, molecules are likely to entangle with each other and a crystal ratio becomes smaller, whereby bending property is improved.

The PTFE itself is poorer than the PFA in the bending property. Therefore, the ratio of the PFA is set more preferably to 80% or greater and particularly preferably to 90-98%. If the ratio of the PFA is set to 90-98%, it is considered that fine powders of PTFE become nucleus of crystal generation during film formation (cooling) with addition of a small amount of PTFE to PFA and growth of crystals to excessively large size can be prevented and thus endurance is improved.

In addition, in the belt or the roller for OA apparatus of the present invention, the PFA used in the base material preferably has a melting point at 300° C. or lower. The PFA having a melting point at 300° C. or lower is referred to as a “morphology-improved PFA”. As compared with a general PFA, the morphology-improved PFA has shorter but more perfluoroalkyl groups. In contrast to the general PFA having a melting point around 305° C., such a morphology-improved PFA has a lower melting point at 285 to 295° C., and as compared with the general PFA, entanglement of molecules is further likely and a crystal ratio (a ratio of a crystal portion to a non-crystal portion) is also small. Therefore, by using the morphology-improved PFA, endurance further better than the general PFA can be achieved.

It is noted that a commercially available morphology-improved PFA may be used as appropriate, and specific examples thereof include Teflon PFA 920HP Plus, Teflon PFA 940HP Plus, Teflon PFA 945HP Plus, Teflon PFA 950HP Plus, and the like, that are commercially available from Du Pont-Mitsui Fluorochemicals Co., Ltd.

From the viewpoint of attaining the effect described above most, the belt for OA apparatus of the present invention is preferably used as a transfer belt or a transfer/fusion belt.

Here, the top layer of the belt or the roller for OA apparatus is required to have moderate conductivity for the following reasons. The transfer belt and the fusion roller bear charges as a result of friction with respect to a transfer material and the like during the course of transfer and fusion. If the conductivity of the top layer of the transfer belt, the fusion roller and the like is too low, a part of toner is attracted to charge-bearing PTFE, PFA or mixture thereof, which adversely affects image-forming. On the other hand, if the conductivity of the top layer is too high, leakage of transfer charges occurs and force attracting toner becomes weak, which leads to detrimental effect such as electrostatic offset.

If the top layer is formed from a fluoroplastic, bond between fluorine and carbon is strong and there is no polar group or functional group. Accordingly, high toner detachability is attained, and very high insulation, that is, surface resistivity of at least 1.0E+15Ω/□ and volume resistivity of at least 1.0E+15 Ωcm, is attained. From the foregoing, normally, an appropriate amount of conductive agent (conductive substance) is blended (added) in the top layer of which base material is formed from the PTFE, the PFA or the mixture thereof as in the present invention, thereby realizing the top layer having moderate conductivity. By blending such a conductive agent, specifically, the top layer having surface resistivity of preferably 9.99E+14Ω/□ or smaller, more preferably 1.00E+14Ω/□ or smaller, and particularly preferably 9.99E+12Ω/□ can be realized. In addition, by blending the conductive agent, the top layer can have surface resistivity of preferably 1.00E+8Ω/□ or greater, more preferably 1.00E+10Ω/□ or greater, and particular preferably 1.00E+11Ω/□ or greater.

Here, a volume resistance value of the entire belt or roller for OA apparatus of the present invention is calculated as the sum of volume resistance values of the base layer and the intermediate layer. Therefore, by making one of the volume resistance values considerably smaller than the other so as to lower influence of the other volume resistance value on the volume resistance value of the entire multilayer endless belt for image-forming apparatus, the volume resistance value of the entire belt or roller for OA apparatus can be controlled solely by controlling one volume resistance value. For example, the volume resistance value of the entire belt or roller for OA apparatus can be controlled by using an amount of blending a conductive agent such as carbon black in the base layer. A preferred volume resistance value of the entire belt or roller for OA apparatus of the present invention is normally in a range from 1.00E+8 to 1.00E+14Ω·cm, although it fluctuates depending of a manner of use.

In the belt or the roller for OA apparatus of the present invention, the surface resistivity of the top layer is set to 9.99E+14Ω/□ or lower, so that the top layer is less susceptible to electrical stress and therefore endurance is improved. As the surface resistivity is lower, endurance is improved. On the other hand, if the surface resistivity is too low, the current adhered for toner movement escapes in a lateral direction, which may adversely affect the image. Accordingly, the surface resistivity is set preferably to 1.00E+8Ω/□ or greater and more preferably to 1.00E+10Ω/□ or greater.

The conductive agent is not particularly limited, however, examples of the conductive agent include metal oxides such as tin oxide, zinc oxide and titanium oxide, electron-conductive fillers such as carbon and inorganic filler, ion-conductive agents such as ion-conductive organic phosphorus salt (see, for example, Japanese Patent Laying-Open No. 8-220907) and quaternary ammonium salt (see, for example, Japanese Patent Laying-Open No. 2003-15432), and the like. Among others, from the viewpoint of resistance control, metal oxides are preferred. The content of the conductive agent is not particularly limited either. If the content of the conductive agent is too high, however, bleed occurs or toner detachability is lowered. On the other hand, if the content of the conductive agent is too low, an intended resistance is not obtained. Therefore, the content is preferably within a range from 0.003 to 3.

Here, for example, if carbon such as acetylene black is blended as the conductive agent in the PTFE, the PFA or the mixture thereof, in many cases, it is difficult to uniformly disperse the carbon in the PTFE, the PFA or the mixture thereof and to stabilize conductivity. Specifically, if the carbon is blended in a dispersion of the PTFE, the PFA or the mixture thereof, carbon particles having conductivity adhere to the PTFE, the PFA or the mixture thereof that has polar group but does not have conductivity. As a mechanism for conduction of the PTFE, the PFA or the mixture thereof, to which carbon particles have been added, is realized by electron hopping, electric resistance suddenly lowers by blending even an extremely small amount of carbon. Therefore, in order to attain uniform dispersion for attaining moderate conductivity, close attention and sophisticated technique are required. In addition, in this case, solely a product of black color can be obtained. In addition, stability of conductivity in the case of variation in an ambient temperature or humidity is good, however, stability of conductivity in the case of voltage variation at the time of transfer or fusion may not be good.

Further, a case where a conductive inorganic filler such as an SnO₂/Sb-based filler, an In₂O₃/Sn-based filler and a ZnO/Al-based filler is employed will be described. The conductive inorganic filler is the same as carbon in that the resistance fluctuates depending on a degree of dispersion and that the product may be colored. Meanwhile, as an amount of addition for attaining a moderate resistance value is great, the resistance value is readily controlled. If the amount of addition is excessively large, elongation or strength of the base material of the top layer may adversely be affected. Specifically, if the conductive inorganic filler is blended in the dispersion of the PTFE, the PFA or the mixture thereof, it is not kneaded into the particles of the PTFE, the PFA or the mixture thereof but merely adheres around the particles thereof, which may prevent integration by fusion of the PTFE, the PFA or the mixture thereof at the time of calcining.

In addition, the ion-conductive agent is able to set any conductivity of the polymer itself, so that variation in the conductivity is less and stability of the conductivity in the case of voltage fluctuation is good. Meanwhile, polar group such as hydroxyl group (OH) is present at the terminal end of the ion-conductive substance. Therefore, if an amount of addition is increased, toner detachability or angle of contact may be lowered. If adaptation to polymer is poor, bleed-out occurs and the resistance value is increased, or a contacted substance may be smeared.

In order to prevent bleed-out, for example, a treatment for stabilization by introducing an ion-conductive agent in a soft segment part of a resin should be performed. Consequently, the ion-conductive agent is used solely in a resin having soft segment (amorphous) such as polyurethane and polyester, a rubber having ions or polar group, or the like (see Japanese Patent Laying-Open No. 2003-20411). On the other hand, as the PTFE and the PFA have no soft segment or polar group, blending of the ion-conductive agent having polarity as it is is difficult in itself In order to address this, a blend accelerator serving as a surfactant (or soap) or as soft segment may be blended, however, bleed-out still occurs even though it is once mixed. In addition, depending on an amount of blend, toner detachability of the top layer may significantly be lowered.

In addition, as ion-conductive organic phosphorus salt that has been used as an effective ion-conductive agent is poor in its effect to lower resistance, it should be blended by approximately 10%, which may adversely affect toner detachability of the top layer. Moreover, phosphorus to be contained is designated as a banned substance among OA apparatus manufacturers, and use thereof is difficult also in this aspect.

In addition to the above, in the belt or the roller for OA apparatus, the top layer should have some mechanical strength and elongation, and from this viewpoint, a type and an amount of the conductive agent to be blended are restricted.

In particular, unlike the roller, as the belt repeatedly experiences great bending and flexion, it is important that the blended conductive agent does not impair mechanical strength of the top layer.

In addition, in the belt or the roller for OA apparatus of the present invention, (RfSO₂)₂NLi (Rf represents perfluoroalkyl group) is preferably blended, as the conductive agent described above, in the PTFE, the PFA or the mixture thereof forming the base material of the top layer. Thus, the belt or the roller for OA apparatus including the top layer having moderate conductivity can be realized in a stable manner, more readily and with lower cost than in the case of blending the conductive agent described above, without adversely affecting toner detachability or the like.

Here, the belt or the roller for OA apparatus of the present invention is preferably used as any one of a transfer belt, a transfer/fusion belt, a development roller, a charge roller, a transfer roller, and a fusion roller. If the belt or the roller for OA apparatus of the present invention is used as any one of a transfer belt, a transfer/fusion belt, a development roller, a charge roller, a transfer roller, and a fusion roller, such an effect attained by blending (RfSO₂)₂NLi that the top layer having the base material formed from the PTFE, the PFA or the mixture thereof is provided with moderate conductivity while maintaining toner detachability, tensile strength and elongation can be exhibited most.

The PTFE and/or the PFA used in the base material of the top layer in the present invention is/are basically molecules structured in such a manner that carbon atoms each bound to two fluorine atoms are aligned. Therefore, (RfSO₂)₂NLi having a similar structure (Rf) where two fluorine atoms are bound to one carbon atom blends into the PTFE, the PFA or the mixture thereof without difficulty in a dispersed manner, although it has polarity. It is as if an alcohol having polar group (hydroxyl group) blends in petroleum not having polarity, because other molecule structure is the same.

In addition, unlike RfSO₃Li for example, (RfSO₂)₂NLi has N (nitrogen atom) in the center of an anion and sulfonyl groups (SO₂) are bound on opposing sides thereof. Therefore, (RfSO₂)₂NLi has five resonance structures and delocalization of negative electricity occurs. Moreover, perfluoroalkyl group (Rf) is bound on the outer side of each of the two sulfonyl groups bound to opposing sides of N. Therefore, negative charges are strongly pulled toward further outside of N located in the center of the anion (toward two Rfs located on opposing ends where fluorine is bound), due to strong electron-withdrawing property of three or more fluorine atoms located on the opposing sides of N. Thus, not only (RfSO₂)₂N⁻ is present in a stable manner as anion but also dissociation of lithium is more likely. In addition, dissociated lithium ions are likely to migrate as a result of molecular vibration of the PTFE, the PFA or the mixture thereof Consequently, if a voltage is externally applied, lithium ions migrate and moderate conductivity of the top layer is exhibited.

In addition, as (RfSO₂)₂NLi is adapted better to the PFA and/or the PTFE than RfSO₃Li, bleed-out is suppressed.

Here, lithium ion is adopted as a cation, because lithium ion has small atomic weight, it readily migrates between base materials in matrix formed for the PTFE, the PFA or the mixture thereof, and therefore excellent and stable conductivity is ensured by addition of a small amount and it does not adversely affect toner detachability of the top layer.

In a power-applied endurance test (simply also referred to as an endurance test) of a transfer belt or the like, mechanical and physical load such as bending significantly affects performance. As described above, endurance in a power-applied state of the top layer provided with ion-conductivity preferably by blending (RfSO₂)₂NLi is significantly improved as compared with the case of addition of an electron-conductive filler, because (RfSO₂)₂NLi is dispersed in the top layer of the order of molecules.

Specific examples of (RfSO₂)₂NLi include (CF₃SO₂)₂NLi, (C₂F₅SO₂)₂NLi, (C₃F₇SO₂)₂NLi, (C₅F₈SO₂)₂NLi, and the like, and among these, (CF₃SO₂)₂NLi or (C₂F₅SO₂)₂NLi is preferred. This is because (CF₃SO₂)₂NLi and (C₂F₅SO₂)₂NLi have small molecular weight of (RfSO₂)₂NLi, prescribed conductivity can be obtained solely by blending a small amount thereof, and therefore undesired influence on the top layer that could occur when other conductive agents are used can be suppressed and the cost can be lowered.

In the belt or the roller for OA apparatus of the present invention, an amount of blending (RfSO₂)₂NLi is not particularly limited, however, 0.003 to 3.0 parts by weight (RfSO₂)₂NLi is preferably blended in 100 parts by weight PTFE, PFA or mixture thereof used for the base material of the top layer. By blending (RfSO₂)₂NLi in an amount in such a range, an amount of blending (RfSO₂)₂NLi where Li⁺ is bound as a cation and perfluoroalkyl group is bound as an anion to opposing ends is appropriate. Therefore, not only the top layer has moderate conductivity but also excellent toner detachability is ensured and lowering in tensile strength and elongation is also little.

If the amount of blending (RfSO₂)₂NLi in 100 parts by weight PTFE, PFA or mixture thereof is smaller than 0.003 part by weight, conductivity may be insufficient. On the other hand, if it exceeds 3.0 parts by weight, toner detachability and tensile strength may be insufficient. In addition, though depending on a type and design of the OA apparatus, from the viewpoint of ensuring moderate conductivity, 0.1 to 1.0 part by weight (RfSO₂)₂NLi is more preferably blended in 100 parts by weight PTFE, PFA or the mixture thereof, and from the viewpoint of ensuring toner detachability, 0.3 to 0.5 part by weight (RfSO₂)₂NLi is particularly preferably blended therein.

In the belt or the roller for OA apparatus of the present invention, by blending (RfSO₂)₂NLi in the PTFE, the PFA or the mixture thereof used for the base material of the top layer, the top layer having the surface resistivity in a range from 1.00E+10 to 9.99E+14Ω/□ preferable among the above-described range (more suitably in a range from 1.00E+11 to 9.99E+12Ω/□) can be realized. Thus, the belt or the roller for OA apparatus capable of exhibiting excellent image-forming capability without electrostatic adhesion of the toner or transfer charge leakage can be realized.

The thickness of the top layer in the belt or the roller for OA apparatus of the present invention is not particularly limited, however, it is preferably in a range from 1 to 30 μm and more preferably in a range from 1 to 15 μm. By forming the top layer having the thickness in the range above, the belt or the roller for OA apparatus having excellent image-forming capability can be realized. Here, the top layer preferably has a thickness of 1 μm or greater, considering decrease in the thickness due to wear. In addition, if the top layer has a thickness greater than 30 μm, flexibility (elasticity) of the intermediate layer which will be described later may be impaired.

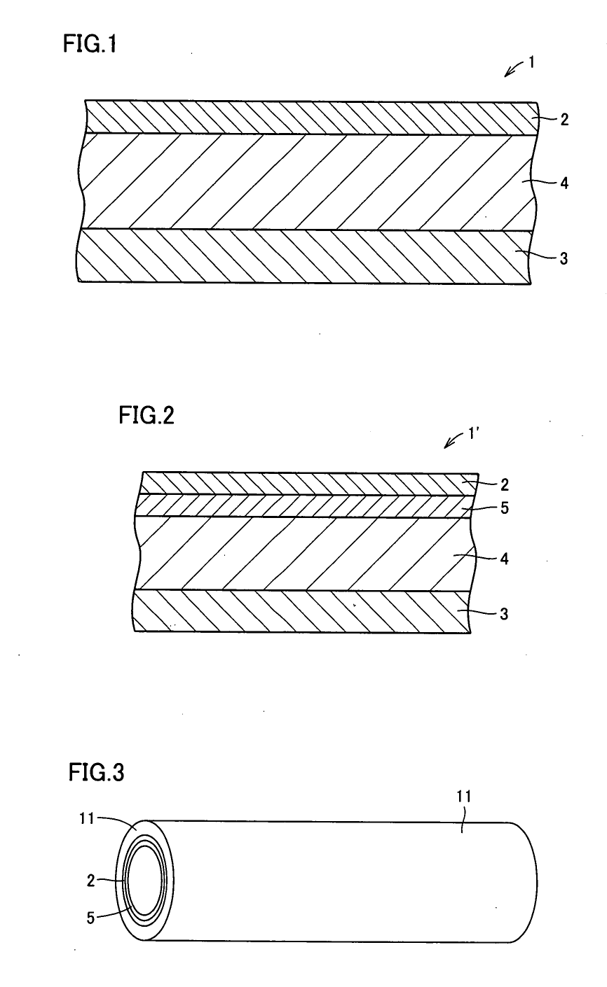

Here, FIG. 1 is a cross-sectional view schematically showing a transfer belt 1 for image-forming apparatus representing a preferred example of the present invention. As described above, the belt or the roller for OA apparatus of the present invention is characterized by its top layer. If the belt or the roller is used in the OA apparatus, normally, it is implemented as a stack (multilayer) structure obtained by stacking other layers. FIG. 1 schematically shows exemplary belt 1 for OA apparatus when it is implemented as a three-layered structure including a top layer 2, a base layer 3 and an intermediate layer 4 interposed therebetween

In the belt or the roller for OA apparatus of the present invention having the structure as shown in FIG. 1, normally, base layer 3 and intermediate layer 4 are formed such that the belt or the roller has desired high tensile modulus of elasticity in the circumferential direction by means of base layer 3, and desired elasticity in the direction of thickness by means of intermediate layer 4. In addition, stable volume resistivity of the belt or the roller can be controlled by selecting a material for forming base layer 3 and intermediate layer 4.

In transfer belt 1 for image-forming apparatus in the example shown in FIG. 1, a material for forming base layer 3 is not particularly limited, however, it is preferably formed from PI (polyimide), PAI (polyamide imide), or PVDF (polyvinylidene fluoride). Base layer 3 desirably has modulus of elasticity not smaller than 1 GPa. Here, by employing aforementioned PI, PAI or PVDF as a material for forming base layer 3, base layer 3 not only having such modulus of elasticity but also excellent in other characteristics such as tensile modulus of elasticity in the circumferential direction, wear resistance, tensile strength, degree of bending, and the like can be realized.

It is noted that base layer 3 is preferably carbon-conductive, by addition of a conductive agent such as carbon black (acetylene black). With carbon-conductive base layer 3, base layer 3 having an appropriate volume resistance value and high modulus of elasticity can be realized, which is preferable from the viewpoint of image forming.

In addition, the thickness of base layer 3 is not particularly limited, however, from the viewpoint of providing high tensile modulus of elasticity in the circumferential direction, the thickness is preferably in a range from 30 to 100 μm and more preferably in a range from 40 to 80 μm.

In transfer belt 1 for image-forming apparatus in the example shown in FIG. 1, a material for forming intermediate layer 4 is not particularly limited, however, it is preferably formed from one type of elastomer or a plurality of types of elastomers selected from urethane, NBR (acrylonitrile-butadiene rubber), EP (ethylene rubber), SR (silicone rubber), and polyamide. By forming intermediate layer 4 from such a material, intermediate layer 4 having moderate flexibility (elasticity) in the direction of thickness can be realized, which is preferable from the viewpoint of image forming. Among these materials, urethane is particularly preferred.

In addition, the thickness of intermediate layer 4 is not particularly limited, however, from the viewpoint of providing moderate flexibility (elasticity) in the direction of thickness, the thickness is preferably in a range from 50 to 300 μm and more preferably in a range from 100 to 250 μm.

In the belt or the roller for OA apparatus having the structure described above, unless electrical characteristics of each layer are appropriate, a product may not be satisfactory. Namely, in the electrophotography, as the image is formed by utilizing static electricity and discharge, an appropriate surface resistance value of each layer, hence stable controllability of a volume resistance value of each layer and the like are required.

In particular, in the case that the belt or the roller for OA apparatus is used as the transfer belt for image-forming apparatus, if the surface resistance value of base layer 3 is smaller than that of intermediate layer 4, a current does not flow from the transfer roller to the photoconductive drum when a voltage is applied between the transfer roller and the photoconductive drum but the current diffuses from the base layer of the transfer belt in contact with the transfer roller in the circumferential direction of the transfer belt, resulting in distorted image.

Accordingly, in the case that the belt or the roller for OA apparatus of the present invention is used as the transfer belt for image-forming apparatus and has the structure obtained by stacking base layer 3, intermediate layer 4 and top layer 2 in this order as in the example shown in FIG. 1, preferably, intermediate layer 4 is formed from an elastomer and the surface resistivity of base layer 3 is greater than that of intermediate layer 4. According to such a transfer belt for image-forming apparatus, when a voltage is applied between the transfer roller and the photoconductive drum, the current flows from the transfer roller to the photoconductive drum, without flowing into base layer 3 of the transfer belt of the present invention in contact with the transfer roller. Therefore, distorted image is unlikely and excellent image-forming capability can be exhibited. In addition, as the transfer belt for image-forming apparatus has a multilayer structure, it is excellent in various mechanical characteristics. Moreover, as intermediate layer 4 formed from an elastomer is provided between base layer 3 and top layer 2, sufficient flexibility in the direction of thickness is obtained.

The transfer belt for image-forming apparatus having elasticity, without collapsing toner, capable of carriage, and adapted to higher image quality, can thus be realized.

In the transfer belt for image-forming apparatus of the present invention, intermediate layer 4 is preferably formed from an ion-conductive elastomer. By forming intermediate layer 4 from the ion-conductive elastomer, the volume resistivity is controlled to a stable value. It is noted that ion-conduction of the elastomer can be achieved, for example, by a method of dispersing an ion-conductive substance such as imidolithium or triflate in the elastomer for providing conductivity.

In addition, in the transfer belt for image-forming apparatus of the present invention, base layer 3 has a surface resistance value preferably at least 200 times and more preferably at least 250 times as great as that of intermediate layer 4. Thus, the surface resistance value of base layer 3 is sufficiently greater than that of intermediate layer 4. Accordingly, when a voltage is applied between the transfer roller and the photoconductive drum, current flow from the transfer roller to the photoconductive drum is ensured and current flow to the transfer belt of the present invention in contact with the transfer roller can reliably be prevented. Namely, image distortion or the like is unlikely.

Specifically, preferably, base layer 3 has surface resistivity in a range from 1.00E+11 to 1.00E+13Ω/□, and intermediate layer 4 has the surface resistance value in a range from 1.00E+8 to 1.00E+11Ω/□. By thus appropriately selecting the surface resistance value of base layer 3 and intermediate layer 4, base layer 3 can have a surface resistance value sufficiently greater than that of intermediate layer 4, so that undesirable current as described above is not generated and excellent image-forming capability can be exhibited.

If base layer 3 has a thickness around 80 μm, base layer 3 preferably has a volume resistance value of approximately 1.00E+9Ωcm. In addition, if intermediate layer 4 has a thickness around 200 μm, intermediate layer 4 has a volume resistance value preferably in a range from 1.00E+6 to 1.00E+8Ωcm and particularly preferably a volume resistance value around 1.00E+7Ωcm.

Here, FIG. 2 is a cross-sectional view schematically showing a transfer belt 1′ for image-forming apparatus representing another preferred example of the present invention. Transfer belt 1′ in the example shown in FIG. 2 is the same as transfer belt 1 in the example shown in FIG. 1 except for further including a binder layer 5 in addition to top layer 2, base layer 3 and intermediate layer 4 described above and having a structure obtained by stacking base layer 3, intermediate layer 4, binder layer 5, and top layer 2 in this order. Portions having a similar structure are given the same reference characters and description thereof will not be provided.

The belt or the roller for OA apparatus of the present invention may alternatively be structured such that binder layer 5 is interposed between intermediate layer 4 and top layer 2, as in the example shown in FIG. 2. Here, a fluorine-containing polymer forming binder layer 5 preferably has a melting point not higher than a point of thermal decomposition of the elastomer forming intermediate layer 4, and a point of thermal decomposition not lower than a melting point of the PTFE, the PFA or the mixture thereof forming the base material of top layer 2.

In the belt or the roller for OA apparatus of the present invention, as described above, the base material of the top layer is formed from the PTFE, the PFA or the mixture thereof. As the PTFE and the PFA are weak in chemical bond between a fluorine atom and a carbon atom forming a backbone of the polymer, adhesion property to other substances is extremely poor. Accordingly, by interposing binder layer 5 formed from the material described above between top layer 2 and intermediate layer 4 as in the example shown in FIG. 2, adhesion between top layer 2 and intermediate layer 4 can reliably be achieved through heat-sealing, thus realizing the belt or the roller for OA apparatus excellent in adhesion property.

In other words, the melting point of the fluorine-containing polymer forming binder layer 5 is not higher than the point of thermal decomposition of the elastomer forming the intermediate layer. Therefore, binder layer 5 and intermediate layer 4 can strongly be heat-sealed to each other by pressing binder layer 5 and intermediate layer 4 against each other while heating the same to a temperature not lower than the melting point and not higher than the point of thermal decomposition of the fluorine-containing polymer forming binder layer 5 and the elastomer forming intermediate layer 4.

In addition, binder layer 5 is formed from the fluorine-containing polymer having the point of thermal decomposition not lower than the melting point of the PTFE, the PFA or the mixture thereof forming the base material of top layer 2. Therefore, binder layer 5 and top layer 2 can be sealed to each other by heating the same to a temperature not lower than the melting point of the PTFE, the PFA or the mixture thereof forming the base material of top layer 2 and not higher than the point of thermal decomposition of the fluorine-containing polymer forming binder layer 5.

Excessive time and effort is not required for forming binder layer 5, a substance contaminating the top layer such as a primer is not mixed, and bleed of a contaminant through a thin top layer is not likely either.

The fluorine-containing polymer used for forming binder layer 5 is preferably a material soluble in a solvent. By using the fluorine-containing polymer soluble in the solvent, the fluorine-containing polymer can be applied to the top layer with a spray method or a dipping method in a state dissolved in the solvent, thus advantageously facilitating manufacturing.

Examples of the preferred fluorine-containing polymer used for forming binder layer 5 include a vinylidene fluoride homopolymer (polyvinylidene fluoride) and a copolymer of two or more types of monomers containing vinylidene fluoride (such as vinylidene fluoride, trifluoroethylene, tetrafluoroethylene, tetrafluoropropylene, and hexafluoropropylene). In particular, among the polymers of monomers containing vinylidene fluoride, polyvinylidene fluoride (PVDF) is particularly preferred. This is because polyvinylidene fluoride has high angle of contact and relatively low melting point, and in many cases, heat-sealing and annealing can be performed at a temperature not deteriorating the intermediate layer formed from urethane (decomposition temperature: approximately 170° C.) or the like (approximately 140 to 160° C.), which results in improved toner detachability.

In addition, examples of the fluorine-containing polymer suitably used for forming binder layer 5 also include a copolymer of tetrafluoroethylene-hexafluoropropylene and vinylidene fluoride (THV). As THV also contains a tetrafluoroethylene component, in addition to having the characteristics described above, THV is advantageous in that it is likely to adhere to the PTFE, the PFA or the mixture thereof forming the base material of top layer 2, there is a grade product having a low melting point at 110° C., its decomposition point is high at 400° C. (not lower than the melting point of the PTFE), adhesion property to urethane or the like is superior, it is soft, and the like. Moreover, as THV has high flexibility, by forming binder layer 5 from THV, flexibility (elasticity) of intermediate layer 4 is not impaired. In addition, THV has relatively low melting point among the fluorine-containing polymers. Therefore, by pressing top layer 2 and intermediate layer 4 against each other with binder layer 5 being interposed at a temperature not deteriorating urethane (decomposition temperature: approximately 170° C.) or the like used for forming intermediate layer 4 (approximately 140 to 160° C.), heat-sealing and annealing of these layers can be performed. Further, as compared with polyvinylidene fluoride (PVDF) described above, THV has higher angle of contact and bleed is less likely, and therefore, it is superior also in its non-contamination property.

In the case that binder layer 5 is interposed between intermediate layer 4 and top layer 2 as in the example shown in FIG. 2, the thickness of binder layer 5 is not particularly limited. If binder layer 5 is too thin, however, sufficient adhesiveness is not obtained. On the other hand, if binder layer 5 is too thick, hardness may be raised. Therefore, the thickness of binder layer 5 is preferably in a range from 1 to 20 μm and more preferably in a range from 3 to 10 μm.

In the case that the belt or the roller for OA apparatus of the present invention is used as the multilayer endless belt for image-forming apparatus and has the structure obtained by stacking base layer 3, intermediate layer 4 and top layer 2 in this order as in the example shown in FIG. 1, preferably, intermediate layer 4 is formed from the elastomer and the surface of top layer 2 on the side adjacent to intermediate layer 4 is subjected to an adhesion property improvement treatment. As described above, the base material of top layer 2 of the present invention is formed from the PTFE, the PFA or the mixture thereof Here, the PTFE, the PFA or the mixture thereof is extremely poor in its adhesion property to other resins. Accordingly, the adhesion surface (inner surface) of top layer 2 of which base material is formed from the PTFE, the PFA or the mixture thereof is subjected to the adhesion property improvement treatment, so that high adhesion property between top layer 2 and intermediate layer 4 can be achieved.

In such a case, only the surface of top layer 2 on the side adhered to intermediate layer 4 is subjected to the adhesion property improvement treatment. Therefore, an outer surface (surface) of top layer 2 in contact with toner or the like is not affected and image-forming capability is not adversely affected.

In such a case, in order to attain satisfactory adhesion between intermediate layer 4 and top layer 2, a layer formed from an adhesive may be interposed therebetween.

Examples of the adhesion property improvement treatment include a treatment for providing polarity to molecules of the PTFE, the PFA or the mixture thereof on the surface of top layer 2 adjacent to intermediate layer 4. A part of the molecule of the PTFE, the PFA or the mixture thereof on the surface of top layer 2 adjacent to intermediate layer 4 has polarity (namely, hydrophilic group) instead of fluorine, so that ensured and reliable adhesion between top layer 2 and intermediate layer 4 can be achieved.

As a method of providing polarity above, for example, a substance (which will be described later) having polarity to be provided to molecules of the PTFE, the PFA or the mixture thereof on the surface of top layer 2 adjacent to intermediate layer 4 is diluted with argon, helium, carbon dioxide, or the like, and the inner surface of the top layer is irradiated, for example, with excimer ultraviolet rays having large energy or plasma in such diluted gas atmosphere. Thus, the molecules of the PTFE, the PFA or the mixture thereof on the surface of top layer 2 adjacent to intermediate layer 4 are excited or some atoms are released, thereby consequently causing reaction of the PTFE, the PFA or the mixture thereof to the substance having polarity.

If urethane is used as the elastomer forming intermediate layer 4, the treatment for providing polarity is preferably a treatment for adding any one of hydroxyl group, carbonyl group, carboxyl group, and amino group. By providing polarity by adding polar group (hydrophilic group) instead of fluorine or hydrogen, particularly by adding any one of hydroxyl group, carbonyl group, carboxyl group, and amino group well-adapted to urethane, to a part of the molecule of the PTFE, the PFA or the mixture thereof on the surface of top layer 2 adjacent to intermediate layer 4, the multilayer endless belt for image-forming apparatus having excellent adhesion property between intermediate layer 4 and top layer 2 can be realized.

The adhesion property improvement treatment may alternatively be a treatment for forming irregularities on the surface of top layer 2 adjacent to intermediate layer 4. By forming irregularities on the surface of top layer 2 adjacent to intermediate layer 4 as well, increase in the area of adhesion to intermediate layer 4 and entanglement are caused, and therefore adhesion property between top layer 2 and intermediate layer 4 is improved.

As the treatment for forming irregularities, a large number of fine and small irregularities are mechanically formed by treating the surface of top layer 2 adjacent to intermediate layer 4, for example, with plasma, blast or radical (a highly reactive substance such as chlorine in an atom state or liquid metal sodium, and a fluorine-removed substance such as lithium alkylate).

The adhesion property improvement treatment may be a treatment for forming irregularities on the surface of top layer 2 adjacent to intermediate layer 4 and thereafter further providing polarity as described above. By performing such an adhesion property improvement treatment, further improvement in adhesion property can be achieved.

Plasma treatment represents a preferred adhesion property improvement treatment. By subjecting the surface of top layer 2 adjacent to intermediate layer 4 to plasma treatment, ensured and reliable adhesion between top layer 2 and intermediate layer 4 can be achieved. Here, “plasma treatment” is not limited to a treatment for causing reaction by plasma irradiation in a gas atmosphere having polarity, so long as plasma irradiation treatment for improving adhesion property is encompassed, and a treatment for mechanically forming irregularities on the surface of top layer 2 adjacent to intermediate layer 4 by plasma irradiation is also encompassed.

Radical treatment also represents another preferred adhesion property improvement treatment. By subjecting the surface of top layer 2 adjacent to intermediate layer 4 to radical treatment as well, ensured and reliable adhesion between top layer 2 and intermediate layer 4 can be achieved. Here, “radical treatment” is not limited to a treatment for mechanically forming irregularities by exposing the surface of top layer 2 adjacent to intermediate layer 4 to radicals, so long as treatment for exposure to radicals for improving adhesion property is encompassed, and chemically binding radical to the PTFE, the PFA or the mixture thereof on the surface of top layer 2 adjacent to intermediate layer 4 or the like is also encompassed.

If the surface of top layer 2 adjacent to intermediate layer 4 is subjected to the adhesion property improvement treatment as described above, top layer 2 has a thickness more preferably in a range from 1 to 15 μm, among the thicknesses mentioned above. By setting the thickness of top layer 2 in a range from 1 to 15 μm, not only sufficient wear resistance and flexibility can both be achieved but also influence of the adhesion property improvement treatment onto the surface of top layer 2 adjacent to intermediate layer 4 does not extend as far as the surface of top layer 2 in contact with the transfer material (paper). In performing the adhesion property improvement treatment, if the thickness of top layer 2 is too small, the adhesion property improvement treatment should be performed carefully. In addition, from the viewpoint of prevention of toner adhesion, top layer 2 has a thickness further preferably in a range from 3 to 8 μm and particularly preferably in a range from 4 to 6 μm.

Moreover, in performing the adhesion property improvement treatment described above, the surface of top layer 2 subjected to the adhesion property improvement treatment is preferably adhered to intermediate layer 4 with heat-sealing. By adhering top layer 2 to intermediate layer 4 using heat-sealing, an adhesive is not necessary, a manufacturing step can be simplified, and in addition, adverse influence on image-forming capability of the multilayer endless belt for image-forming apparatus due to the use of an adhesive is also unlikely.

In the case that the belt or the roller for OA apparatus of the present invention is used as the multilayer endless belt for image-forming apparatus and has the structure obtained by stacking base layer 3, intermediate layer 4, binder layer 5, and top layer 2 in this order as in the example shown in FIG. 2, the surface of binder layer 5 adjacent to intermediate layer 4 may be subjected to the adhesion property improvement treatment as described above. In this case as well, as described above, preferably, intermediate layer 4 is formed from an elastomer, and binder layer 5 is formed from the fluorine-containing polymer having the melting point not higher than the point of thermal decomposition of the elastomer forming intermediate layer 4 and the point of thermal decomposition not lower than the melting point of the PTFE, the PFA or the mixture thereof forming the base material of top layer 2.

The present invention also provides an OA apparatus using the belt or the roller for OA apparatus of the present invention. As the OA apparatus of the present invention employs the belt or the roller for OA apparatus of the present invention as described above, the OA apparatus of the present invention has excellent image-forming capability.

A method of manufacturing the belt or the roller for OA apparatus of the present invention having the structure obtained by successively stacking base layer 3, intermediate layer 4 and top layer 2 shown in FIG. 1 or the structure obtained by successively stacking base layer 3, intermediate layer 4, binder layer 5, and top layer 2 shown in FIG. 2 will be described hereinafter. Though the belt or the roller for OA apparatus of the present invention can suitably be manufactured with the method described below, it is not limited to those manufactured with this method.

In forming top layer 2 in the belt or the roller for OA apparatus of the present invention, initially, a dispersion is prepared by dispersing fine particles of the PTFE, the PFA or the mixture thereof forming the base material and a conductive agent in water. Here, metal oxides, Rf(SO₂)₂NLi (Rf represents perfluoroalkyl group) and the like described above can be used as the conductive agent. In addition, the tetrafluoroethylene-hexafluoropropylene copolymer, the tetrafluoroethylene-ethylene copolymer or the like described above may be added, so long as the effect of the present invention is not impaired. Here, the PTFE, the PFA or the mixture thereof and the conductive agent are blended at such a ratio that the PTFE, the PFA or the mixture thereof occupies at least 70% of the base material in weight excluding the conductive agent, in a state where top layer 2 is formed.

In preparing the dispersion, dispersion property is preferably improved by means of a bead mill, a disper, a homogenizer, and the like. By improving dispersion property of the dispersion, concentration of electric load or concentration of physical and/or mechanical stress is prevented and endurance of the top layer can further be improved. Among others, the homogenizer is preferably used to improve dispersion property.

Thereafter, as shown in FIG. 3, the prepared dispersion is applied, with a dipping method, to the inner surface of an outer cylinder 11, for example, having the inner surface mirror-finished, followed by calcining. For example, the temperature for calcining is set to 320 to 420° C. (particularly 380° C.). For example, a member in a cylindrical shape made of stainless steel (SUS) (coefficient of thermal expansion: 1.76×10⁻⁵/° C.) or a member in a cylindrical shape formed from a rigid body made of steel (coefficient of thermal expansion: 1.76×10⁻⁷/° C.) may be used as outer cylinder 11. Thus, top layer 2 having the base material formed from the PTFE, the PFA or the mixture thereof and having the continuous structure can be formed.

FIG. 3 shows an example in which binder layer 5 is further stacked on the inner circumferential surface of top layer 2. In forming binder layer 5, for example, a THV polymer (melting point: 120° C.) is fused in butyl acetate, and a film thereof is formed with a dipping method on top layer 2 followed by drying. After binder layer 5 is thus formed, binder layer 5 is preferably subjected to a treatment for brining binder layer 5 into intimate contact with top layer 2 by heating at a temperature (for example 350° C.) between the melting point of the PTFE, the PFA or the mixture thereof forming the base material of top layer 2 and the melting point of the THV. A composite body constituted of top layer 2 and binder layer 5 formed as above may be herein referred to as a “first composite body”.

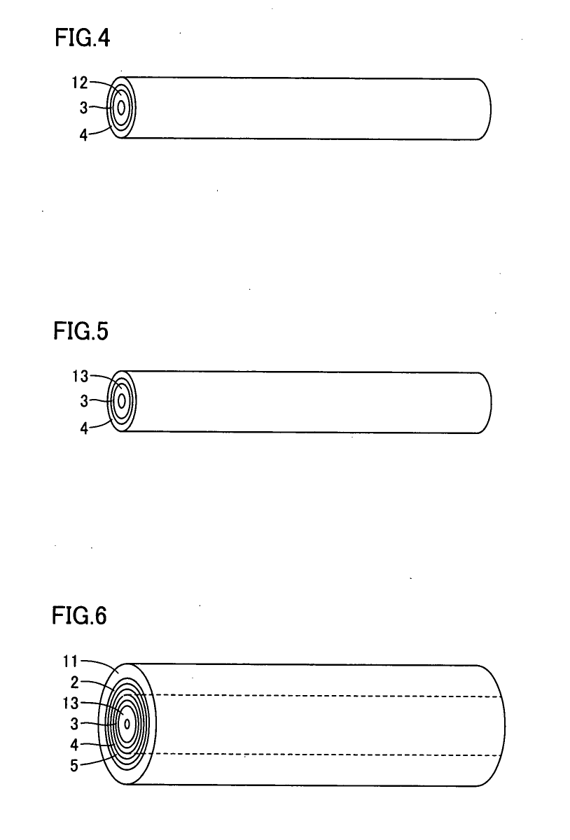

Base layer 3 and intermediate layer 4 can be fabricated, for example, in the following manner. Initially, while rotating a drum-shaped mold 12 as shown in FIG. 4, for example, a polyimide varnish is applied to the outside of the mold. Thereafter, mold 12 is heated for imidization, thereby forming base layer 3 covering the outer circumference of mold 12.

Thereafter, for example, a thickener is added, for example, to aqueous urethane (melting point: 120° C., point of thermal decomposition: 180° C.) to attain viscosity around 10 Pa·s, degassing is further performed, and thereafter the resultant substance is applied onto base layer 3 with a dipping method. After application, the resultant substance is dried at room temperature, thereby forming intermediate layer 4. A composite body constituted of base layer 3 and intermediate layer 4 formed as above may be herein referred to as a “second composite body”.

Here, by adjusting as appropriate an amount of adding a conductive agent (such as carbon black) to be added to base layer 3 and intermediate layer 4, the transfer belt for image-forming apparatus where base layer 3 has the surface resistance value greater than that of intermediate layer 4 as described above can be manufactured. Here, adjustment is made, for example, such that base layer 3 has a volume resistance value of 1.00E+9 Ωcm and surface resistivity of 1.00E+12Ω/□, and intermediate layer 4 has a volume resistance value of 1.00E+8 Ωcm and surface resistivity of 1.00E+8Ω/□ (these resistance values are values measured at 100V herein).

In addition, in manufacturing the transfer belt for image-forming apparatus where base layer 3 has the surface resistance value greater than that of intermediate layer 4 as described above, base layer 3 and intermediate layer 4 may be fabricated in the following manner. Initially, the surface of drum 12 is subjected to a carbon-conduction treatment, a film of polyimide of which volume resistivity has been adjusted (for example, to 1.00E+9 Ωcm) is formed, followed by calcining (temperature for calcining is set, for example, to 380° C.), thereby forming base layer 3. Thereafter, aqueous urethane, that has been subjected to an ion-conduction treatment for achieving ion-conduction and of which volume resistance value has been adjusted (for example, to 1.00E+7 Ωcm), is applied onto base layer 3 with a dipping method followed by drying, thereby forming intermediate layer 4. It is noted that the ion-conduction treatment may be performed, for example, by dispersing an ion-conductive agent in aqueous urethane.

Thereafter, the belt or the roller for OA apparatus is fabricated by performing heat-sealing of top layer 2 or the first composite body formed as described above to the second composite body. Specifically, if solely top layer 2 is formed within outer cylinder 11 and top layer 2 is heat-sealed to the second composite body, the structure where base layer 3, intermediate layer 4 and top layer 2 are successively stacked as in the example shown in FIG. 1 can be obtained. On the other hand, if the first composite body is formed in outer cylinder 11 (see FIG. 3) and the first composite body is heat-sealed to the second composite body, the structure where base layer 3, intermediate layer 4, binder layer 5, and top layer 2 are successively stacked as in the example shown in FIG. 2 can be obtained.

If the surface of top layer 2 adjacent to intermediate layer 4 (in the case of the structure in FIG. 1) described above or the surface of binder layer 5 adjacent to intermediate layer 4 (in the case of the structure in FIG. 2) is subjected to the adhesion property improvement treatment, top layer 2 or binder layer 5 in the first composite body before heat-sealing described above can be subjected to the adhesion property improvement treatment.

Here, in manufacturing the multilayer endless belt having the structure shown in FIG. 1, the present invention encompasses a manufacturing method including the steps of fabricating the composite body (second composite body) in which intermediate layer 4 formed from an elastomer is formed on base layer 3, subjecting the surface of top layer 2 adjacent to intermediate layer 4 to the adhesion property improvement treatment, and adhering intermediate layer 4 of the composite body (second composite body) to the surface of top layer 2 subjected to the adhesion property improvement treatment as described above.

In addition, in manufacturing the multilayer endless belt having the structure shown in FIG. 2, the present invention also encompasses a manufacturing method including the steps of fabricating the composite body (second composite body) in which intermediate layer 4 formed from an elastomer is formed on base layer 3, forming binder layer 5 from a specific fluorine-containing polymer as described above on one surface of top layer 2 (namely, fabricating the first composite body described above), subjecting the surface of binder layer 5 opposite to the side adjacent to top layer 2 (namely, the surface adjacent to intermediate layer 4) to the adhesion property improvement treatment, and adhering the composite body (second composite body) to the surface of binder layer 5 subjected to the adhesion property improvement treatment as described above.

In the method of manufacturing the multilayer endless belt of the present invention, the adhesion property improvement treatment is preferably a treatment for providing polarity to the molecules on the surface of top layer 2 or binder layer 5 adjacent to intermediate layer 4, as described above. Here, the preferred method of providing polar group and polarity is as described above.

In addition, in the method of manufacturing the multilayer endless belt of the present invention, in subjecting top layer 2 to the adhesion property improvement treatment, an agent removing fluorine atom from the molecules of the PTFE, the PFA or the mixture thereof on the surface of top layer 2 adjacent to intermediate layer 4 may be applied, followed by washing. In the present invention, the PTFE, the PFA or the mixture thereof on the surface of top layer 2 adjacent to intermediate layer 4 is formed by chained molecules mainly as a result of bond of a large number of “—CF₂—”. Here, the agent (such as sodium naphthalene complex) chemically removes fluorine atom from the chain, thereby causing an electron-deficient state of the carbon atom. Thereafter, when the carbon atom in this state is exposed to air or a cleaning liquid, the electron-deficient state is eliminated by oxygen, water, vapor, or the like, and adhesive functional group, that is, polar group such as hydroxyl group, carboxyl group and carbonyl group is formed, thereby significantly improving adhesion property.

Specifically, for example, an agent (such as sodium naphthalene complex “Tetraetch” manufactured by Technos Corporation; product name) removing fluorine atom from the PTFE, the PFA or the mixture thereof on an inner circumferential surface of top layer 2 formed in outer cylinder 11 as described above (that is, the surface on the side adjacent to intermediate layer 4) is lightly applied to the inner circumferential surface, followed by washing with alcohol after 3 to 7 seconds.

Alternatively, in the method of manufacturing the multilayer endless belt of the present invention, the adhesion property improvement treatment described above may be a treatment for forming irregularities on the surface of top layer 2 or binder layer 5 adjacent to intermediate layer 4. Alternatively, in the method of manufacturing the multilayer endless belt of the present invention, the adhesion property improvement treatment performed on the surface of top layer 2 or binder layer 5 adjacent to intermediate layer 4 may be plasma treatment or radical treatment as described above.

Specifically, for example, the inner circumferential surface of binder layer 5 of the first composite body fabricated as described above is exposed to corona discharge, to form irregularities.

Further, in another specific example, blasting in which fine silica particles are blown to the inner circumferential surface of binder layer 5 of the first composite body fabricated as described above using compressed air is performed, thereby roughening the inner circumferential surface and densely forming small irregularities.

In manufacturing the belt or the roller for OA apparatus of the present invention, adhesion between top layer 2 or binder layer 5 (preferably subjected to the adhesion property improvement treatment as described above) and intermediate layer 4 is carried out generally with the following three methods.

As a first method, a method of employing a core 13 formed from a material having a coefficient of thermal expansion greater than that of outer cylinder 11 having top layer 2 or the first composite body (top layer 2 and binder layer 5) formed on its inner circumferential surface as described above is available. For example, as shown in FIG. 4, the second composite body (base layer 3 and intermediate layer 4) is stacked on the outer circumference of drum-shaped mold 12. The second composite body is removed from mold 12 and the second composite body formed in a cylindrical shape is fitted to the outer circumference of core 13 as shown in FIG. 5. A core formed from a material having a coefficient of thermal expansion greater than that of outer cylinder 11 is used as core 13. Outer cylinder 11 made of SUS and core 13 made of PA6 (for example, nylon mainly composed of nylon 6 such as MC nylon; coefficient of thermal expansion 8.0×10⁷/° C.) are given as an exemplary combination of materials for outer cylinder 11 and core 13.

Thereafter, as shown in FIG. 6, core 13 to which the second composite body consisting of base layer 3 and intermediate layer 4 is fitted is inserted in outer cylinder 11 having top layer 2 or the first composite body (the first composite body in the example shown in FIG. 6) formed on the inner circumferential surface. Heating is performed in such a state, to carry out heat-sealing between top layer 2 or binder layer 5 and intermediate layer 4. The temperature for heating in heat-sealing can be set, for example, to 150° C. in the case of adhesion between top layer 2 and intermediate layer 4, and for example, to 150° C. in the case of adhesion between binder layer 5 and intermediate layer 4. It is noted that the entire outer cylinder and core are preferably placed in a vacuum atmosphere at the time of heat-sealing.

Heat-sealing is thus performed using core 13 having a coefficient of thermal expansion greater than that of outer cylinder 11, and heating of both of the outer cylinder and the core or the entire outer cylinder and core is performed while core 13 is inserted in outer cylinder 11 as described above in such a range that resins are not altered. By utilizing a difference in thermal expansion between core 13 and outer cylinder 11, heat-sealing while pressing the adhesion surface can be performed.

As described above, as the inner circumferential surface of outer cylinder 11 is mirror-finished, top layer 2 is mirror-finished if top layer 2 or the first composite body is formed on the inner circumferential surface thereof In addition, detachment from the inner circumferential surface of outer cylinder 11 after heat-sealing of the second composite body as described above is also facilitated.

Thereafter, core 13 and outer cylinder 11 are cooled, so that a stack structure of three layers (base layer 3, intermediate layer 4 and top layer 2) or four layers (base layer 3, intermediate layer 4, binder layer 5, and top layer 2) is removed, thereby obtaining the belt or the roller for OA apparatus of the present invention having the structure shown in FIG. 1 or 2.

In the method of manufacturing the belt or the roller for OA apparatus of the present invention for manufacturing the multilayer endless belt having the structure shown in FIG. 1, in which the surface of top layer 2 adjacent to intermediate layer 4 is subjected to the adhesion property improvement treatment, the step of adhering intermediate layer 4 of the composite body to the surface of top layer 2 on the side subjected to the adhesion property improvement treatment preferably includes the following steps (a1) to (a4) as described above:

(a1) forming and fixing step of forming and fixing top layer 2 on the inner circumference of outer cylinder 11 made of a rigid body, with the adhesion surface side facing inside;

(a2) attachment step of attaching the composite body (second composite body) to the outer circumference of core 13 made of a material having a coefficient of thermal expansion greater than that of outer cylinder 11, with intermediate layer 4 facing outside;

(a3) insertion step of inserting core 13 to which the composite body (second composite body) is attached in outer cylinder 11 having top layer 2 fixed to its inner circumference; and

(a4) adhesion step of adhering top layer 2 and intermediate layer 4 of the composite body (second composite body) to each other by heating both of outer cylinder 11 and core 13 in a state that core 13 is inserted in outer cylinder 11.

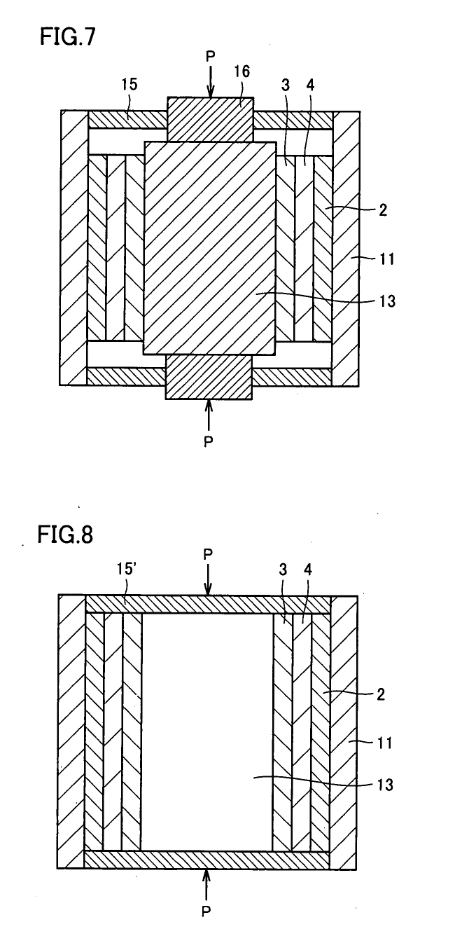

As a second method, a method of employing core 13 formed from an elastic body is available. For example, a core made of silicone rubber may be used as core 13. The second composite body removed from mold 12 as described above is fitted to the outer circumference of core 13 made of elastic body, and thereafter core 13 is further inserted in outer cylinder 11 having top layer 2 or the first composite body formed on the inner circumferential surface. In this state, for example, as in the example shown in FIG. 7, a lid 15 in a ring shape for maintaining vacuum is placed, blocks 16 are placed on respective upper and lower ends of core 13, and a space inside is evacuated using a vacuum pump (not shown). Thereafter, heating is performed and opposing ends of core 13 is pressed with lids 15 in a ring shape for maintaining vacuum, with block 16 being interposed (pressing force is shown with P in FIG. 7).

Core 13 made of elastic body is used and heat-sealing is thus performed while opposing ends of core 13 are pressed, and heating of both of the outer cylinder and the core or the entire outer cylinder and core is performed while core 13 is inserted in outer cylinder 11 as described above in such a range that resins are not altered. A diameter in a trunk portion of core 13 is thus made larger and heat-sealing while pressing the adhesion surface can be performed.

For example, a block made of MC nylon described above may be employed as block 16 used in the example shown in FIG. 7. Alternatively, instead of such a block, for example, as shown in the example in FIG. 8, outer cylinder 11 and core 13 having the same length may be used and a lid having a size sufficient for covering an opening of outer cylinder 11 may be used as a lid 15′ for maintaining vacuum, so as to press opposing ends of core 13 using lid 15′ itself.

Thereafter, as in the case of the first method described above, core 13 and outer cylinder 11 are cooled, a stack structure of three layers (base layer 3, intermediate layer 4 and top layer 2) or four layers (base layer 3, intermediate layer 4, binder layer 5, and top layer 2) is removed, thereby obtaining the belt or the roller for OA apparatus of the present invention having the structure shown in FIG. 1 or 2 (the examples in FIGS. 7 and 8 both show a case that a stack structure of three layers is formed).

In the method of manufacturing the belt or the roller for OA apparatus of the present invention for manufacturing the multilayer endless belt having the structure shown in FIG. 1, in which the surface of top layer 2 adjacent to intermediate layer 4 is subjected to the adhesion property improvement treatment, the step of adhering intermediate layer 4 of the composite body to the surface of top layer 2 on the side subjected to the adhesion property improvement treatment preferably includes the following steps (b1) to (b5) as described above:

(b1) forming and fixing step of forming and fixing top layer 2 on the inner circumference of outer cylinder 11 made of a rigid body, with the adhesion surface side facing inside;

(b2) attachment step of attaching the composite body (second composite body) to the outer circumference of core 13 made of elastic body, with intermediate layer 4 facing outside;

(b3) insertion step of inserting core 13 to which the composite body (second composite body) is attached in outer cylinder 11 having top layer 2 fixed to its inner circumference;

(b4) pressing step of pressing intermediate layer 4 of the composite body (second composite body) against top layer 2 by making larger the diameter of the trunk portion of core 13 by pressing opposing ends of core 13 in a state that core 13 is inserted in outer cylinder 11; and

(b5) adhesion step of adhering top layer 2 and intermediate layer 4 of the composite body (second composite body) to each other by heating both of outer cylinder 11 and core 13 in a state that core 13 is inserted in outer cylinder 11.

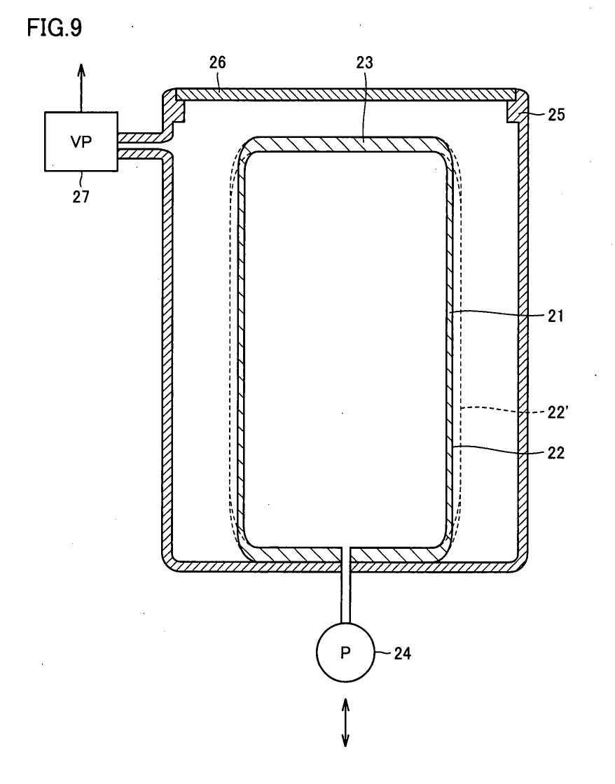

As a third method, a method of using a water bag in a hollow cylindrical shape having opposing ends closed, of which radius can be increased and decreased by regulating a pressure of a fluid filling the inside, is available. FIG. 9 schematically shows a water bag 21 that can suitably be used in manufacturing the belt or the roller for OA apparatus of the present invention. A material for water bag 21 in the example shown in FIG. 9 is not particularly limited. From the viewpoint that flexibility is not lost up to high temperature of approximately 200 to 250° C. and detachability from resin is satisfactory, however, a trunk portion 22 thereof is preferably formed from an elastic body such as silicone rubber. Water bag 21 in the example shown in FIG. 9 can be greater or smaller in diameter, from a state shown with a solid line to a state shown with a dashed line 22′. End plates 23 are connected to respective upper and lower ends of trunk portion 22 of water bag 21, and a pump 24 is coupled to a part thereof. Actually, a structure of each portion is rather complicated. Specifically, there is a complicated sealing structure for connection between trunk portion 22 and end plate 23 of water bag 21. Such a structure, however, is not shown, because it has little to do with the gist of the present invention.

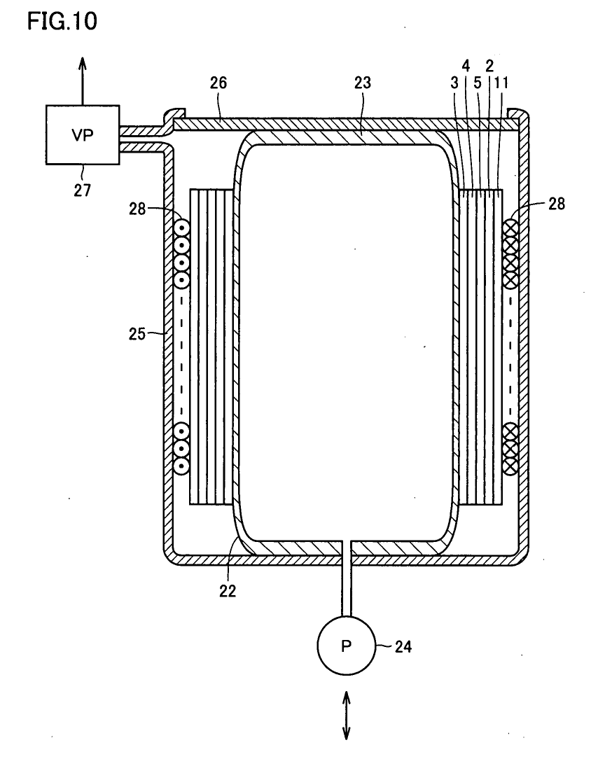

The second composite body is attached to the outer circumference of such water bag 21 with intermediate layer 4 facing outside, and water bag 21 in such a state is inserted in top layer 2 or the first composite body (top layer 2 and binder layer 5) formed on the inner circumferential surface of outer cylinder 11. FIG. 10 shows an example where the second composite body attached to the outer circumference of water bag 21 is inserted in the first composite body formed on the inner circumferential surface of outer cylinder 11 such that intermediate layer 4 is adjacent to binder layer 5. Water bag 21 in such a state is accommodated in a vacuum chamber 25 having a freely-opening/closing lid 26 in the upper portion, while pump 24 is coupled to water bag 21. A vacuum pump 27 is coupled to vacuum chamber 25, such that the space inside vacuum chamber 25 can attain a vacuum state. In addition, as shown in FIG. 10, an electric heater 28 for heating is attached to the inner circumferential surface of vacuum chamber 25.

While water bag 21 is accommodated in vacuum chamber 25, the pressure of the fluid in trunk portion 22 of water bag 21 is increased by means of pump 24, to expand trunk portion 22. In order to maintain self-supporting property, trunk portion 22 can have a thickness, for example, of 10 mm. Here, such a thickness has no adverse influence on expansion of trunk portion 22. In addition, trunk portion 22 is preferably formed to have a smaller thickness in its central portion, so that gas escapes satisfactorily from the center of the adhesion surface in the side direction (upward and downward).

The second composite body attached to the outer circumference of water bag 21 and top layer 2 or the first composite body formed on the inner circumferential surface of outer cylinder 11 are pressed against each other, by outer cylinder 11 and trunk portion 22 of water bag 21 that has expanded as a result of internal pressure. In this case, for example, if outer cylinder 11 made of stainless steel is used, deformation of outer cylinder 11 due to pressing above can be prevented. On the other hand, trunk portion 22 of water bag 21 is fabricated as a film formed from elastic body such as silicon rubber. Therefore, if a fluid pressure in water bag 21 is raised, for example, to 100 atmospheres, a resin layer is pressed against the inner circumferential surface of outer cylinder 11 uniformly as a whole, regardless of whether end plates 23 on opposing ends are present or not.

Here, air in vacuum chamber 25 is exhausted by vacuum pump 27, and therefore, vacuum chamber 25 is under vacuum. In addition, by heating vacuum chamber 25 with electric heater 28 (for example, to 120 to 150° C.) in a state that trunk portion 22 of water bag 21 is expanded as described above, adhesion between intermediate layer 4 and top layer 2 or binder layer 5 can be achieved uniformly and reliably.

Thereafter, atmospheric pressure is recovered in vacuum chamber 25 and vacuum chamber 25 is cooled to a room temperature, thus lowering the fluid pressure in water bag 21. Then, outer cylinder 11 having a stack structure of three layers (base layer 3, intermediate layer 4 and top layer 2) or four layers (base layer 3, intermediate layer 4, binder layer 5, and top layer 2) attached on the inner circumferential surface is taken out. Thereafter, by removing the stack structure of three layers or four layers from outer cylinder 11, the belt or the roller for OA apparatus shown in FIG. 1 or 2 above can be obtained.

In the method of manufacturing the belt or the roller for OA apparatus of the present invention for manufacturing the multilayer endless belt having the structure shown in FIG. 1, in which the surface of top layer 2 adjacent to intermediate layer 4 is subjected to the adhesion property improvement treatment, the step of adhering intermediate layer 4 of the composite body to the surface of top layer 2 on the side subjected to the adhesion property improvement treatment preferably includes the following steps (c1) to (c6) as described above:

(c1) forming and fixing step of forming and fixing top layer 2 on the inner circumference of outer cylinder 11 made of a rigid body, with the adhesion surface side facing inside;

(c2) attachment step of attaching the composite body (second composite body) to the outer circumference of water bag 21 in a hollow cylindrical shape having opposing ends closed, of which radius can be increased and decreased by regulating a pressure of a fluid filling the inside, with intermediate layer 4 facing outside;

(c3) insertion step of inserting water bag 21 to which the composite body (second composite body) is attached in top layer 2 fixed to the inner circumference of outer cylinder 11;

(c4) vacuum step of producing vacuum in an ambient space including the inner circumference of outer cylinder 11 made of a rigid body and the outer circumference of water bag 21, after the insertion step is completed:

(c5) pressing step of pressing the outer circumferential surface of intermediate layer 4 of the composite body (second composite body) attached to the outer circumference of water bag 21 against top layer 2 fixed to the inner circumference of outer cylinder 11 made of a rigid body, by making larger the diameter of water bag 21 by increasing the pressure of the fluid filling water bag 21, after the insertion step is completed; and

(c6) adhesion step of adhering top layer 2 and intermediate layer 4 of the composite body (second composite body) to each other by heating, after the vacuum step and the pressing step are completed.

Though not described in detail, in addition to the above, adhesion between intermediate layer 4 and top layer 2 or binder layer 5 may be achieved, for example, by utilizing explosive force.

Alternatively, in manufacturing the belt or the roller for OA apparatus of the present invention, adhesion between intermediate layer 4 and base layer 3 may naturally be achieved by using the heat-sealing method as described above (that is, the method of using the core having a great coefficient of thermal expansion, the method of using the core made of elastic body, and the method of using the water bag).

In addition, in manufacturing the multilayer endless belt having the structure shown in FIG. 1, in which the surface of top layer 2 adjacent to intermediate layer 4 is subjected to the adhesion property improvement treatment, the method of manufacturing the belt or the roller for OA apparatus of the present invention also encompasses a method including the steps of subjecting one surface of top layer 2 to the adhesion property improvement treatment by applying an agent removing fluorine atom from the PTFE, the PFA or the mixture thereof on one surface of top layer 2 followed by washing, fabricating the composite body by forming intermediate layer 4 on the surface of top layer 2 subjected to the adhesion property improvement treatment (the composite body constituted of top layer 2 and intermediate layer 4 is referred to as a “third composite body”), and adhering base layer 3 to intermediate layer 4 of the fabricated composite body (third composite body).

Here, the step of adhering base layer 3 and intermediate layer 4 of the fabricated third composite body to each other preferably includes the following steps (d1) to (d4), similar to steps (a1) to (a4) in adhesion of intermediate layer 4 and top layer 2 to each other described above:

(d1) forming and fixing step of forming and fixing the composite body (third composite body) on the inner circumference of outer cylinder 11 made of a rigid body, with intermediate layer 4 facing inside;

(d2) attachment step of attaching the composite body (third composite body) to the outer circumference of core 13 made of a material having a coefficient of thermal expansion greater than that of outer cylinder 11, with base layer 3 facing outside;

(d3) insertion step of inserting core 13 to which base layer 3 is attached in outer cylinder 11 having the composite body (third composite body) fixed to its inner circumference; and

(d4) adhesion step of adhering top layer 2 and intermediate layer 4 of the composite body (third composite body) to each other by heating both of outer cylinder 11 and core 13 in a state that core 13 is inserted in outer cylinder 11.

Alternatively, the step of adhering base layer 3 and intermediate layer 4 of the fabricated third composite body to each other may include the following steps (e1) to (e5), similar to steps (b1) to (b5) in adhesion of intermediate layer 4 and top layer 2 to each other described above:

(e1) forming and fixing step of forming and fixing the composite body (third composite body) on the inner circumference of outer cylinder 11 made of a rigid body, with intermediate layer 4 facing inside;

(e2) attachment step of attaching the composite body (third composite body) to the outer circumference of core 13 made of elastic body, with base layer 3 facing outside;

(e3) insertion step of inserting core 13 to which base layer 3 is attached in outer cylinder 11 having intermediate layer 4 of the composite body (third composite body) fixed to its inner circumference;

(e4) pressing step of pressing base layer 3 against the composite body (third composite body) by making larger the diameter of the trunk portion of core 13 by pressing opposing ends of core 13 in a state that core 13 is inserted in outer cylinder 11; and

(e5) adhesion step of adhering base layer 3 and intermediate layer 4 of the composite body (third composite body) to each other by heating both of outer cylinder 11 and core 13 in a state that core 13 is inserted in outer cylinder 11.

Further alternatively, the step of adhering base layer 3 and intermediate layer 4 of the fabricated third composite body to each other may include the following steps (f1) to (f6), similar to steps (c1) to (c6) in adhesion of intermediate layer 4 and top layer 2 to each other described above:

(f1) forming and fixing step of forming and fixing the composite body (third composite body) on the inner circumference of outer cylinder 11 made of a rigid body, with intermediate layer 4 facing inside;

(f2) attachment step of attaching base layer 3 to the outer circumference of water bag 21 in a hollow cylindrical shape having opposing ends closed, of which radius can be increased and decreased by regulating a pressure of a fluid filling the inside, with base layer 3 facing outside;

(f3) insertion step of inserting water bag 21 to which base layer 3 is attached in the composite body (third composite body) fixed to the inner circumference of outer cylinder 11;

(f4) vacuum step of producing vacuum in an ambient space including the inner circumference of outer cylinder 11 made of a rigid body and the outer circumference of water bag 21, after the insertion step is completed:

(f5) pressing step of pressing the outer circumferential surface of base layer 3 attached on the outer circumference of water bag 21 against the composite body (third composite body) fixed to the inner circumference of outer cylinder 11 made of a rigid body, by making larger the diameter of water bag 21 by increasing the pressure of the fluid filling water bag 21, after the insertion step is completed; and

(f6) adhesion step of adhering base layer 3 and intermediate layer 4 of the composite body (third composite body) to each other by heating, after the vacuum step and the pressing step are completed.

The belt or the roller for OA apparatus of the present invention may be manufactured with the following method.

Initially, as described above, after base layer 3 is formed on drum-shaped mold 12, intermediate layer 4 is further formed on base layer 3. A dispersion for forming top layer 2 described above is applied onto thus formed intermediate layer 4 with a method such as spray coating, followed by drying and calcining, thus forming top layer 2. Thus, the belt or the roller for OA apparatus may be manufactured, without adopting a method of adhering intermediate layer 4 to top layer 2 or binder layer 5 that are separately formed as described above.

When this method is adopted as well, binder layer 5 may be formed on intermediate layer 4 and top layer 2 may be formed on binder layer 5. In such a case, however, if THV and PTFE are used as the materials for binder layer 5 and the base material of top layer 2 respectively, it is difficult to form top layer 2 by calcining, because the THV has the melting point at 120° C. and the PTFE has the melting point at 327° C. Therefore, in manufacturing the belt or the roller for OA apparatus structured as such, a method of adhering binder layer 5 and intermediate layer 4 to each other, that are separately formed as described above, is preferably adopted.

In the following, the present invention will be described in further detail with reference to experiment examples, however, the present invention is not limited thereto.

### EXPERIMENT EXAMPLE 1

The following experiment was conducted, using a sample of the transfer belt having the structure shown in FIG. 1. The sample of the transfer belt used in the present experiment example has the three-layered structure of base layer 3 formed from polyimide (thickness: 80 μm), intermediate layer 4 formed from urethane (thickess: 250 μm) and top layer 2 (thickness: 7 μm) of which base material is formed from materials shown in Tables 1 to 4 which will be described later. The sample has an inner diameter of 168φ and a width of 368 mm. Top layer 2 has the surface resistivity of 1.00E+11Ω/□ except for the case shown in Table 4.

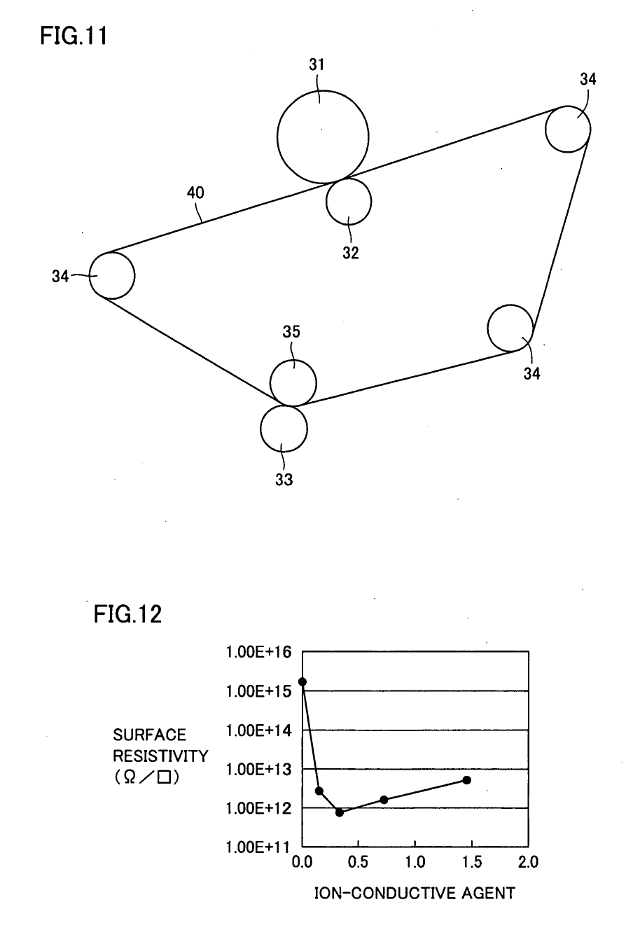

An actually used Xerox-type color printer (color printer Docuprint C620 manufactured by Fuji Xerox Co., Ltd.) was used in the test. FIG. 11 conceptually shows the substantial part of this apparatus. The apparatus shown in FIG. 11 includes a photoconductive drum 31, a primary transfer roller 32, a secondary transfer roller 33, a φ30 roller 34 (having an outer diameter of 30 mm), and a φ28 roller 35 (having an outer diameter of 28 mm). A sample 40 of the transfer belt described above was attached to such an apparatus as shown in FIG. 11 and the apparatus was actually driven for the test.

In FIG. 11, sample 40 of the transfer belt bends along the outer circumferential surface of roller 34 and roller 35 and returns to a straight state in a linear portion, thereby receiving physical and/or mechanical stress. In addition, as a voltage of several kV is applied between primary transfer roller 32 and secondary transfer roller 33, sample 40 receives electrical stress. Accordingly, the top layer of sample 40 of the transfer belt deteriorates with increase in the paper feed count. It is noted that, in the color printer having a mechanism the same as that in the example of FIG. 11, as toner of cyan, magenta, yellow, and black is successively formed on the transfer belt, sample 40 receives stress four times in one printing operation.

In the following, a result of various tests will be described with reference to tables.

Table 1 shows the result of the test of toner detachability.

TABLE 1

| | Product Name | Manufacturer | Material | 1-1 | 1-2 | 1-3 | 1-4 | 1-5 | 1-6 |
|---|---|---|---|---|---|---|---|---|---|
| Base | KYNER9301 | ATOFINA JAPAN | PVDF | 100 | 100 | — | — | — | — |
| Material | DY-01 | Daido Corporation | acrylic urethane | — | — | 100 | 100 | — | — |
| | | | paint | | | | | | |
| | D1-F | Daikin Industries, | PTFE | — | — | — | — | 100 | — |
| | | Ltd. | | | | | | | |
| | 350J | Du Pont-Mitsui | general-purpose | — | — | — | — | — | 100 |
| | | | PFA | | | | | | |
| Additive | Lubron | Daikin Industries, | PTFE powder | — | 100 | — | 100 | — | — |
| | | Ltd. | | | | | | | |
| Evaluation | Toner | — | — | C | B | C | B | A | A |
| | detachability | | | | | | | | |
| | Endurance | — | — | 2 m or | 340 | 280 | 0 | 16.2k | 688k |
| | | | | greater | | | | | |

Endurance in Table 1 is represented by the paper feed count until crack or wrinkling appears in the top layer. In Table 1, k represents 1000 (kilo) and m represents 1,000,000 (mega). It is assumed that paper count with regard to endurance required in the transfer belt is at least 100,000 (look) and preferably 1,000,000 (1 m).

In addition, the amount of blend in Table 1 is denoted as a ratio (parts) to 100 parts “base material”.

Meanwhile, whether toner detachability is good or poor was determined based on whether or not a blade for scraping toner off could remove chemical toner. In addition, A, B and C in the field of toner detachability represent pass, failure and complete failure, respectively.

It can be seen from Table 1 that, turning to samples 1-1 to 1-4 of the transfer belt, in order to improve toner detachability of samples 1-1 and 1-3 of the transfer belt according to the conventional technique, PTFE powder should be blended, while endurance (resistance to bending) of transfer belts 1-2 and 1-4 where PTFE powder was blended is significantly low.

Meanwhile, it can be seen that sample 1-6 of the transfer belt in which the base material of top layer 2 is formed from the PFA and has the continuous structure is excellent in both of toner detachability and endurance.

In addition, it can be seen that sample 1-5 of the transfer belt in which the base material of top layer 2 is formed from the PFFE and has the continuous structure is superior to samples made of acryl and the like in endurance and excellent in toner detachability.

Meanwhile, Table 2 shows relation between endurance and the amount of blending the PTFE and the PFA used for forming the base material of the top layer.

TABLE 2

| | Product Name | Manufacturer | Material | 2-1 | 2-2 | 2-3 | 2-4 | 2-5 | 2-6 | 2-7 | 2-8 |
|---|---|---|---|---|---|---|---|---|---|---|---|
| Base | D1-F | Daikin | PTFE | 100 | 50 | 35 | 20 | 10 | 5 | 2 | — |
| Material | | Industries, Ltd. | | | | | | | | | |
| | 350J | Du Pont-Mitsui | general-purpose PFA | — | 50 | 65 | 80 | 90 | 95 | 98 | 100 |
| Evaluation | Toner | — | — | A | A | A | A | A | A | A | A |
| | detachability | | | | | | | | | | |
| | Endurance | — | — | 16.2k | 72k | 281k | 554k | 891k | 1.082 m | 973k | 688k |

It can be seen from Table 2 that the more the PFA is blended, the more endurance is improved at an accelerated pace. This may be because molecules are readily entangled with each other and the crystal ratio becomes smaller, as perfluoroalkyl group is added to the PFA.

In addition, turning to samples 2-1 and 2-2 of the transfer belt, it can be seen that endurance is improved if the PFA is added to the PTFE. In particular, turning to samples 2-5, 2-6 and 2-7 of the transfer belt, it can be seen that endurance is drastically improved by adding a small amount of PFA to the PTFE. This can be interpreted to mean that fine powders of PTFE serve as nucleus of crystal generation during film formation (cooling) and that crystals could be controlled such that they do not grow excessively large.

Table 3 shows a case that a morphology-improved product was used for the base material of top layer 2 as well as influence of MFR of the PTFE and the PFA used for forming the base material on endurance.

TABLE 3

| | | | | | Melting | | | | | |
|---|---|---|---|---|---|---|---|---|---|---|
| | | | | | Point | | | | | |
| | Product Name | Manufacturer | Material | MFR | (° C.) | 3-1 | 3-2 | 3-3 | 3-4 | 3-5 |
| Base | 350J | Du Pont-Mitsui | general-purpose PFA | 2 | 305 | 100 | — | — | — | — |
| Material | 920HP | Du Pont-Mitsui | morphology-improved | 30 | 285 | — | 100 | — | — | — |
| | | | PFA | | | | | | | |
| | 940HP | Du Pont-Mitsui | morphology-improved | 14 | 295 | — | — | 100 | — | — |
| | | | PFA | | | | | | | |
| | 945HP | Du Pont-Mitsui | morphology-improved | 7 | 295 | — | — | — | 100 | — |
| | | | PFA | | | | | | | |
| | 950HP | Du Pont-Mitsui | morphology-improved | 2 | 295 | — | — | — | — | 100 |
| | | | PFA | | | | | | | |
| Evaluation | Toner | — | — | — | — | A | A | A | A | A |
| | detachability | | | | | | | | | |
| | Endurance | — | — | — | — | 688k | 323k | 780k | 1.18 m | 1.21 m |

As can be seen from Table 3, if the MFR is the same, sample 3-1 of the transfer belt in which the base material of top layer 2 is formed from general-purpose PFA is better in endurance than sample 3-5 of the transfer belt in which the base material of top layer 2 is formed from the morphology-improved product. This may be because the morphology-improved product has a greater number of perfluoroalkyl groups and a smaller crystal ratio than general-purpose PFA.

In addition, turning to samples 3-2 to 3-5 of the transfer belt in particular, it can be seen that as the MFR is smaller, endurance is better. Though not shown in Table 3, if the MFR is less than 2, there is no flow in calcining (fusion), and therefore, it is difficult to form a uniform film.

Table 4 shows influence of the surface resistivity onto endurance.

TABLE 4

| | Product Name | Manufacturer | 4-1 | 4-2 | 4-3 | 4-4 | 4-5 |
|---|---|---|---|---|---|---|---|
| Base | 950HP | Du Pont-Mitsui | 100 | 100 | 100 | 100 | 100 |
| Material | FS-10P | Ishihara Sangyo | 0 | 3 | 5 | 7 | 9 |
| Evaluation | Surface resistivity (Ω/□) | — | E+15 | E+13 | E+11 | E+10 | E+7 |
| | Toner detachability | — | A | A | A | A | A |
| | Endurance | — | 1.5k | 422k | 1.21 m | 1.81 m | 2 m or greater |

In samples 4-1 to 4-5 of the transfer belt shown in Table 4, unlike the samples of the transfer belt shown in Tables 1 to 3, the surface resistivity was not fixed to 1.00E+11Ω/□ but was varied. Table 4 shows how endurance is varied in accordance with such variation in the surface resistivity. In Table 4, numeric values in the row of FS-10P represent parts by weight of the conductive agent blended in 100 parts by weight 950HP used as the base material.

In addition, in Table 4, “E+” such as “E+15” in the field of the surface resistivity represents the power of 10. Therefore, “E+15” means 15th power (unit: Ω/□).

It can be seen from Table 4 that endurance is improved as the surface resistivity is lowered and the belt is less susceptible to electrical stress. On the other hand, it can be seen that, if the surface resistivity is not larger than E+10, the current adhered for toner movement escapes in a lateral direction, which may adversely affect the image, and therefore, the surface resistivity greater than that is required.

### EXPERIMENT EXAMPLE 2

For preparing samples 1 to 4, samples, that are obtained by blending 0.185, 0.370, 0.741, and 1.481 part by weight ion-conductive agent (imidolithium, (CF₃SO₂)₂NLi, product name Sankonol AQ-50R, solid content 50.0 weight %) manufactured by Sanko Chemical Industry Co., Ltd. in 100 parts by weight PFA grade 950HP (solid content 33.5 weight %) of a PFA dispersion (liquid substance obtained by floating PFA fine particles of submicron order in water) manufactured by Du Pont-Mitsui Fluorochemicals Co., Ltd., respectively, were mixed for 30 minutes using a blade-stirring apparatus, so as to sufficiently uniformly dissolve the ion-conductive agent in the PFA dispersion.

Thereafter, viscosity of the PFA dispersion in which the ion-conductive agent was dissolved was measured with a B-type viscometer. After the viscosity was adjusted, the PFA dispersion was applied, with a dipping method, to the inner surface of a cylinder made of stainless steel having the inner surface mirror-finished, followed by calcining at 360° C., thus obtaining a PFA film of a thickness of 8 to 8.5 μm.

In addition, for preparing sample 5, the PFA dispersion without containing the ion-conductive agent was solely applied to fabricate the PFA film of a thickness of 8.5 μm.

Moreover, for preparing samples 6 to 8, the PFA films of a thickness of 8 μm, that are obtained by blending CF₃SO₃Li (ion-conductive agent manufactured by Sanko Chemical Industry Co., Ltd., triflate, product name Sankonol AQ-50T, solid content 50 weight %) having solely a single perfluoroalkyl sulfonic group in the PFA dispersion the same as that for samples 1 to 5, in amounts 1.00, 5.00 and 10.00 part(s) by weight CF₃SO₃Li in 100 parts by weight PFA, were fabricated with the method the same as in the case of samples 1 to 5.

For preparing sample 9, the PFA film of a thickness of 8 μm, obtained by blending 5 parts by weight needle-shaped conductive tin oxide (FS-10P manufactured by Ishihara Sangyo Kaisha Ltd., particle size: major axis 1 μm×minor axis 0.01 μm) in 100 parts by weight PFA and applying the dispersion in which needle-shaped conductive tin oxide is dispersed in the PFA dispersion the same as that for samples 1 to 5, was fabricated with the method the same as in the case of samples 1 to 5, except for dispersion of a filler. In the case of the filler, as dispersion with the blade-stirring apparatus is insufficient, a homogenizer with high performance was used.

Here, the needle-shaped filler was used for the following reasons. Specifically, for example, a filler having a spherical shape such as FS-100P (particle size 0.01 μm) manufactured by Ishihara Sangyo Kaisha Ltd. should be blended at least 10 parts by weight in order to lower surface resistance down to 1.00E+12Ω/□, and strength and elongation of the film are significantly lowered.

Under the conditions above, elongation in a vertical (length, circumference) direction, tensile strength in the vertical direction, endurance, and the surface resistivity at each test voltage were measured for each PFA film. Taking into account viewability and ease of understanding, except for endurance, the results of the test of samples 1 to 5 and samples 6 to 9 and 2 are shown in Tables 5 and 6, respectively. In addition, the results of endurance of samples 2, 5 and 9 are shown in Table 7.

TABLE 5

| | | Sample 1 | Sample 2 | Sample 3 | Sample 4 | Sample 5 |
|---|---|---|---|---|---|---|
| PFA dispersion | PFA (950HP) | 100 | 100 | 100 | 100 | 100 |
| | Water or the | 198.5 | 198.5 | 198.5 | 198.5 | 198.5 |
| | like | | | | | |
| Ion-conductive | (CF₃SO₂)₂NLi | 0.185 | 0.370 | 0.741 | 1.481 | 0 |
| agent | | | | | | |
| Thickness (μm) | | 8.5 | 8.5 | 8 | 8 | 8.5 |
| Elongation | 1 | 270 | 190 | 223 | 267 | 327 |
| (vertical) (%) | 2 | 280 | 253 | 250 | 237 | 320 |
| | 3 | 257 | 277 | 283 | 267 | 290 |
| | Average | 269 | 240 | 252 | 257 | 312 |
| Tensile | 1 | 2.82 | 2.24 | 2.24 | 2.75 | 3.44 |
| strength | 2 | 2.94 | 2.71 | 2.47 | 2.38 | 3.22 |
| (vertical) | 3 | 2.71 | 2.94 | 2.94 | 2.75 | 2.67 |
| (kg/mm²) | Average | 2.82 | 2.63 | 2.55 | 2.57 | 3.11 |
| Surface | 10 V | 1.60E+13 | 1.66E+12 | 2.09E+12 | 2.86E+13 | 8.12E+13 |
| resistivity of | 50 V | 3.68E+12 | 8.41E+11 | 2.28E+12 | 6.16E+12 | 7.08E+14 |
| top layer (Ω/□) | 100 V | 2.89E+12 | 7.20E+11 | 1.84E+12 | 4.74E+12 | 1.47E+15 |
| | 250 V | 2.45E+12 | 5.58E+11 | 1.40E+12 | 3.89E+12 | 2.10E+16 |
| | 500 V | 2.23E+12 | 4.76E+11 | 1.20E+12 | 3.52E+12 | 1.00E+16 |

TABLE 6

| | | Sample 6 | Sample 7 | Sample 8 | Sample 9 | Sample 2 |
|---|---|---|---|---|---|---|
| PFA dispersion | PFA (950HP) | 100 | 100 | 100 | 100 | 100 |
| | Water or the | 198.5 | 198.5 | 198.5 | 198.5 | 198.5 |
| | like | | | | | |
| Needle-shaped conductive tin | | — | — | — | 5 | — |
| oxide (FS-10P) | | | | | | |
| Ion-conductive | CF₃SO₃Li | 1.00 | 5.00 | 10.00 | — | — |
| agent | (CF₃SO₂)₂NLi | — | — | — | — | 0.370 |
| Thickness (μm) | | 8 | 8 | 8 | 8 | 8.5 |
| Elongation | 1 | 243 | 130 | 207 | 140 | 190 |
| (vertical) | 2 | 273 | 107 | 167 | 127 | 253 |
| (%) | 3 | 227 | 93 | 207 | 150 | 277 |
| | Average | 248 | 110 | 194 | 139 | 240 |
| Tensile strength | 1 | 2.67 | 2.00 | 2.25 | 2.14 | 2.24 |
| (vertical) | 2 | 2.83 | 1.75 | 2.00 | 2.14 | 2.71 |
| (kg/mm²) | 3 | 2.50 | 1.75 | 2.25 | 2.29 | 2.94 |
| | Average | 2.67 | 1.83 | 2.17 | 2.19 | 2.63 |
| Surface resistivity | 10 V | 1.33E+14 | 2.60E+14 | 2.14E+10 | 2.10E+11 | 1.66E+12 |
| of top layer | 50 V | 1.20E+15 | 7.55E+12 | 2.43E+10 | 1.98E+11 | 8.41E+11 |
| (Ω/□) | 100 V | 4.10E+15 | 4.11E+12 | 2.68E+10 | 1.92E+11 | 7.20E+11 |
| | 250 V | 2.80E+16 | 1.45E+12 | 2.83E+10 | 1.72E+11 | 5.58E+11 |
| | 500 V | 1.10E+16 | 7.60E+11 | 2.94E+10 | 1.44E+11 | 4.76E+11 |

TABLE 7

| | Sample 2 | Sample 5 | Sample 9 |
|---|---|---|---|
| Conductive agent | (CF₃SO₂)₂NLi | none | Needle-shaped |
| | | | conductive tin oxide |
| Amount of blending | 0.370 | 0 | 5.00 |
| conductive agent | | | |
| (parts by weight) | | | |
| Endurance | 3.0 m≦ | 1.5k | 1.2 m |

Here, endurance is represented by the paper feed count until crack or wrinkling appears in the top layer. Specifically, as the belt is rotated while wound on a plurality of rollers, the belt is caused to bend along the outer circumferential surface of the roller and to return to a straight state in a linear portion, thereby repeatedly receiving physical and/or mechanical stress. Particularly, in the color printer, as toner of cyan, magenta, yellow, and black is successively formed on the transfer belt, the belt receives stress four times in one printing operation. Accordingly, the top layer deteriorates with increase in the paper feed count. Here, it is assumed that the paper feed count required in the transfer belt is at least 100,000 and preferably at least 1,000,000. Here, in order to check whether sufficient endurance is attained in spite of blending of the ion-conductive agent, the test for checking endurance was conducted.

As to the dimension other than the top layer of the transfer belt used in the test, the transfer belt has an inner diameter of 168 mm and a width of 368 mm, the base layer has a thickness of 80 μm, and the intermediate layer has a thickness of 250 μm. The actually used Xerox-type color printer (color printer Docuprint C620 manufactured by Fuji Xerox Co., Ltd.) was used in the test, and its outline is as shown in FIG. 11. In the field of endurance in Table 7, k represents 1000 (kilo) and m represents 1,000,000 (mega).

In addition, FIGS. 12, 13 and 14 show variation in surface resistivity, tensile strength and elongation until rupture, when the amount of blending the ion-conductive agent in samples 1 to 4 is varied.

In samples 6 to 8, in order to attain the conductivity in a range from 1.00E+10 to 9.99E+14Ω/□, the ion-conductive agent should be blended up to 5 parts by weight, as can readily be seen from the comparison with samples 1 to 4 shown in Table 5 or with sample 2 shown in the right end of Table 6. Namely, in order to attain the same conductivity, CF₃SO₃Li approximately 10 times as much as (CF₃SO₂)₂NLi should be blended. This may be because CF₃SO₃Li has solely a single perfluoroalkyl sulfonic group and therefore capability of the fluorine atom to withdraw ions becomes weak and dissociation of Li ions is less likely.

If 5 parts by weight ion-conductive agent is blended, elongation is less than half of samples 1 to 4, and tensile strength is also lowered to approximately 70% thereof. In addition, toner detachability is also lower.

The surface resistivity of the PFA film of sample 9 in which needle-shaped conductive tin oxide is blended is not particularly problematic, however, it can be seen that elongation is less than half and strength is lowered to approximately ⅔, as compared with the PFA film with nothing blended. In addition, toner detachability is also lower.

As can be seen from Table 7, endurance of sample 2 is much better than sample 9. The reason is considered as follows. In sample 9 in which the filler is blended, the filler is scattered in the resin in the top layer. Accordingly, not only mechanical and/or physical stress but also electrical stress are applied to that portion in a concentrated manner, and a defect is caused in the fluoroplastic film. On the other hand, in sample 2 in which the ion-conductive agent is blended, as the conductive agent is dispersed on a molecular level, such a phenomenon does not take place.

Samples 1 to 4 will now be considered. It can be seen from Table 5 that the surface resistivity tends to lower (the conductivity tends to increase) as the applied voltage increases from 10V to 50V, 100V, 250V, and 500V, with some exceptions, regardless of a ratio of blending the ion-conductive agent. The surface resistivity in all samples, however, is within a range from 4.76E+11Ω/□ to 2.86E+13Ω/□, that is, a moderate value is attained.

FIG. 12 shows how the surface resistivity of the PFA film at the voltage of 100V is varied in accordance with the amount of blending the ion-conductive agent. It can be seen from FIG. 12 that, though the surface resistivity is lowered to some extent when 0.370 part by weight ion-conductive agent is blended, the surface resistivity is substantially constant in the case of blending 0.185 part by weight to 1.481 part by weight, that is, in a range from 7.20E+11Ω/□ to 4.74E+12Ω/□, although the result is shown in a logarithmic graph. Therefore, the surface resistivity does not significantly vary with slight fluctuation in the number of parts of blending the ion-conductive agent, and hence blending treatment is facilitated.

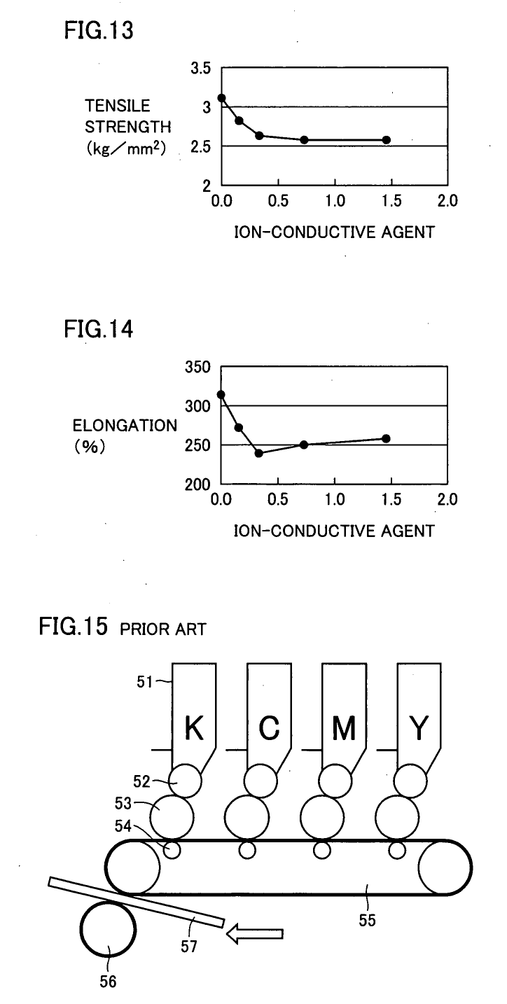

FIG. 13 shows how the tensile strength of the PFA film is varied in accordance with the increase in the amount of blending the ion-conductive agent. In FIG. 13, though the tensile strength of the PFA film slightly lowers if up to 0.370 part by weight ion-conductive agent is blended, significant lowering is not observed even if the ion-conductive agent is blended more, at least until blending 1.481 part by weight. Therefore, the tensile strength is not significantly lowered with slight fluctuation in the amount of blending the ion-conductive agent, and hence blending treatment is facilitated.

FIG. 14 shows how the elongation until rupture of the PFA film is varied in accordance with the increase in the amount of blending the ion-conductive agent. In FIG. 14, though the elongation of the PFA film slightly lowers if up to 0.370 part by weight ion-conductive agent is blended, significant lowering is not observed even if the ion-conductive agent is blended more, at least until blending 1.481 part by weight. Therefore, the elongation is not significantly varied with slight fluctuation in the amount of blending the conductive agent, and hence blending treatment is facilitated.

It is noted that bleed-out of the ion-conductive agent was observed in none of samples 1 to 4.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A belt or a roller for OA apparatus, wherein
a top layer includes a base material formed from PTFE, PFA or a mixture thereof and having a continuous structure; and
the PTFE, the PFA or the mixture thereof occupies at least 70% of the base material in weight, excluding a conductive agent.

2. The belt or the roller for OA apparatus according to claim 1, wherein
melt flow rate of the PTFE, the PFA or the mixture thereof forming said base material is at most 14 g/10 minutes (372° C., load 5 kg).

3. The belt or the roller for OA apparatus according to claim 1, wherein
said base material is formed from a mixture of the PTFE and the PFA, and the PFA occupies 50 weight % with respect to total weight of the PTFE and the PFA.

4. The belt or the roller for OA apparatus according to claim 1, wherein
said base material is formed from the PFA or a mixture of the PFA and the PTFE having a melting point of at most 300° C.

5. The belt or the roller for OA apparatus according to claim 1, used as a transfer belt or a transfer/fusion belt.

6. The belt or the roller for OA apparatus according to claim 1, used as any one of a transfer belt, a transfer/fusion belt, a development roller, a charge roller, and a fusion roller for image-forming apparatus, wherein
(RfSO₂)₂NLi where Rf represents perfluoroalkyl group is blended in the PTFE, the PFA or the mixture thereof forming the base material.

7. The belt or the roller for OA apparatus according to claim 6, wherein
said (RfSO₂)₂NLi is (CF₃SO₂)₂NLi or (C₂F₅SO₂)₂NLi.

8. The belt or the roller for OA apparatus according to claim 6, wherein
0.003 to 3.0 parts by weight (RfSO₂)₂NLi is blended in 100 parts by weight PTFE, PFA or the mixture thereof

9. The belt or the roller for OA apparatus according to claim 6, wherein
said top layer has surface resistivity in a range from 1.00E+10 to 9.99E+14Ω/□.

10. The belt or the roller for OA apparatus according to claim 6, wherein said top layer has a thickness in a range from 1 to 30 μm.

11. The belt or the roller for OA apparatus according to claim 1, used as a transfer belt for image-forming apparatus, wherein
said transfer belt for image-forming apparatus has such a structure that a base layer, an intermediate layer formed from an elastomer and said top layer are stacked in this order, and
said base layer has surface resistivity higher than that of said intermediate layer.

12. The belt or the roller for OA apparatus according to claim 11, wherein
said intermediate layer is formed from an ion-conductive elastomer.

13. The belt or the roller for OA apparatus according to claim 11, wherein
said intermediate layer is formed from one type of elastomer or a plurality of types of elastomers selected from urethane, NBR, EP, SR, and polyamide.

14. The belt or the roller for OA apparatus according to claim 11, wherein
a binder layer formed from a fluorine-containing polymer is interposed between said intermediate layer and said top layer, and
said binder layer is formed from a material having a melting point equal to or lower than a point of thermal decomposition of the elastomer forming said intermediate layer, and a point of thermal decomposition equal to or higher than a melting point of the PTFE, the PFA or the mixture thereof forming the base material of said top layer.

15. The belt or the roller for OA apparatus according to claim 1, used as a multilayer endless belt for image-forming apparatus, wherein
said multilayer endless belt for image-forming apparatus has such a structure that a base layer, an intermediate layer formed from an elastomer and said top layer are stacked in this order, and
a surface of said top layer on a side adjacent to the intermediate layer is subjected to an adhesion property improvement treatment.

16. The belt or the roller for OA apparatus according to claim 15, wherein
said adhesion property improvement treatment is a treatment for providing polarity to a molecule of the PTFE, the PFA or the mixture thereof on the surface of the top layer adjacent to the intermediate layer.

17. The belt or the roller for OA apparatus according to claim 15, wherein
said adhesion property improvement treatment is a plasma treatment.

18. The belt or the roller for OA apparatus according to claim 15, wherein
said surface of said top layer subjected to the adhesion property improvement treatment is adhered to said intermediate layer by heat-sealing.

19. A method of manufacturing the belt or the roller for OA apparatus according to claim 15, comprising the steps of:
fabricating a composite body having the intermediate layer formed on the base layer;
fabricating the top layer having one surface subjected to the adhesion property improvement treatment; and
adhering the intermediate layer of the composite body to the surface of the top layer subjected to the adhesion property improvement treatment.

20. An OA apparatus comprising the belt or the roller for OA apparatus according to claim 1.
